(19) United States
(12) Patent Application Publication
(10) Pub. No.: US 2020/0089370 A1
(43) Pub. Date: Mar. 19, 2020

(54) MESH ELECTRODE

(71) Applicant: 3M INNOVATIVE PROPERTIES COMPANY, St. Paul, MN (US)

(72) Inventors: Thomas Herdtle, Inver Grove Heights, MN (US); Billy L. Weaver, Eagan, MN (US); Matthew H. Frey, Cottage Grove, MN (US)

(21) Appl. No.: 16/472,073

(22) PCT Filed: Dec. 13, 2017
(86) PCT No.: PCT/IB2017/057908

§ 371 Date: Jun. 20, 2019

Related U.S. Application Data
(60) Provisional application No. 62/436,769, filed on Dec. 20, 2016.

(51) Int. Cl. G06F 3/044

(52) U.S. Cl. CPC G06F 3/0446; G06F 2203/04112

(57) ABSTRACT

A continuously electrically conductive electrode including an electrically conductive first mesh repeating across the electrode to form a two-dimensional regular array of the first mesh is described. The first mesh includes a plurality of conductive closed cells, each closed cell including a plurality of vertices connecting a plurality of electrically conductive traces. The electrode may also include an electrically conductive second mesh different from the first mesh and including a plurality of conductive closed cells, each closed cell including a plurality of vertices connecting a plurality of electrically conductive traces. A majority of the closed cells in at least one of the first and second meshes have irregularly arranged vertices.

### BACKGROUND

The use of metal-based conductor mesh for applications where light transmission and electrical conductance are needed is known in the art. Examples of such applications include shielding for electromagnetic interference, electrodes for displays (e.g., liquid crystal displays, organic light emitting diode displays), and touch sensors for displays.

### SUMMARY

In some aspects of the present description, a continuously electrically conductive electrode including an electrically conductive first mesh repeating across the electrode to form a two-dimensional regular array of the first mesh and including an electrically conductive second mesh different from the first mesh is provided. The first mesh includes a plurality of conductive closed cells with each closed cell including a plurality of vertices connecting a plurality of electrically conductive traces. The electrically conductive second mesh includes a plurality of conductive closed cells with each closed cell including a plurality of vertices connecting a plurality of electrically conductive traces. The vertices in the plurality of vertices in each closed cell for at least one of the first and second meshes are irregularly arranged.

In some aspects of the present description, a continuously electrically conductive tiled electrode including a first plurality of tiles arranged along a first direction and including a first plurality of pairs of adjacent tiles is provided. Each pair of adjacent tiles in the first plurality of pairs of adjacent tiles includes a common border and a same plurality of irregularly arranged electrically conductive traces with each conductive trace extending across the common border at a crossover point and having a continuous first derivative at the crossover point.

In some aspects of the present description, a continuously electrically conductive electrode including an electrically conductive first mesh repeating across the electrode to form a two-dimensional regular array of the first mesh is provided. The first mesh includes a plurality of conductive closed cells with each of a majority of the closed cells in the plurality of closed cells including a plurality of irregularly arranged vertices connecting a plurality of electrically conductive curved traces.

In some aspects of the present description, a continuously electrically conductive mesh including a plurality of vertices connecting a plurality of electrically conductive traces is provided. The mesh can be divided into a plurality of same size and shape grid cells forming a continuous two-dimensional grid, where a perimeter of each grid cell intersects a plurality of irregularly arranged electrically conductive traces in the plurality of electrically conductive traces without passing through a vertex in the plurality of vertices.

In some aspects of the present description, a capacitive touch sensitive apparatus configured to detect a location of an applied touch by detecting a change in a coupling capacitance is provided. The capacitive touch sensitive apparatus includes a touch sensitive viewing area; a plurality of spaced apart electrically conductive first electrodes disposed in the touch sensitive viewing area and extending along a first direction; and a plurality of spaced apart electrically conductive second electrodes disposed in the touch sensitive viewing area and extending along a different second direction. At least one of the first and second electrodes includes an electrically conductive first mesh repeating across the electrode to form a regular array of the first mesh. The first mesh includes a plurality of conductive closed cells with each closed cell having a plurality of irregularly arranged vertices connecting a plurality of electrically conductive traces.

In some aspects of the present description, a method of designing a mesh tile configured to be repeatedly tiled along at least a first direction to form a continuous tiled mesh is provided. The method includes the steps of: providing a perimeter of a mesh tile; forming a plurality of closed cells within and away from the perimeter with each closed cell having a plurality of vertices connecting a plurality of traces; and forming a plurality of open cells along the perimeter with each open cell including at least one trace terminating at the perimeter, such that when the mesh tile is repeatedly tiled along at least a first direction to form a tiled mesh along the at least first direction, for each pair of adjacent mesh tiles having portions of the perimeters thereof overlapping each other to form a common border of the adjacent mesh tiles, each of at least a plurality of pairs of corresponding open cells at the common border in the adjacent mesh tiles combine to form a corresponding combined closed cell.

In some aspects of the present description, a mesh tile configured to be repeatedly tiled along at least a first direction to form a continuous tiled mesh is provided. The mesh tile includes a perimeter; a plurality of closed cells within and away from the perimeter with each closed cell including a plurality of vertices connecting a plurality of traces; and a plurality of open cells along the perimeter with each open cell including at least one trace terminating at the perimeter, such that when the mesh tile is repeatedly tiled along at least a first direction to form a tiled mesh along the at least first direction, for each pair of adjacent mesh tiles having portions of the perimeters thereof overlapping each other to form a common border of the adjacent mesh tiles, each of at least a plurality of pairs of corresponding open cells at the common border in the adjacent mesh tiles combine to form a corresponding combined closed cell. For each of at least a plurality of combined closed cells, the combined closed cell has a plurality of irregularly arranged vertices.

In some aspects of the present description, a mesh tile configured to be repeatedly tiled along at least a first direction to form a continuous tiled mesh is provided. The mesh tile includes a perimeter; a plurality of closed cells within and away from the perimeter with each closed cell having a plurality of vertices connecting a plurality of traces; and a plurality of open cells along the perimeter with each open cell including at least one trace terminating at the perimeter, such that for each first open cell in the plurality of open cells along the perimeter, there is a different second open cell in the plurality of open cells along the perimeter that when translated linearly along at least one direction, combines with the first open cell to form a combined closed cell having a plurality of irregularly arranged vertices.

### BRIEF DESCRIPTION OF THE DRAWINGS

FIG. 1A is a schematic top view of an electrode;

FIG. 1B is a schematic top view of a region of the electrode of FIG. 1A;

FIG. 2 is a schematic top view of an electrode;

FIG. 3A is a schematic top view of an array of electrodes;

FIG. 3B is a schematic top view of mesh tiles;

FIG. 3C is a schematic top view of the mesh tiles of FIG. 3B superimposed on the array of electrodes of FIG. 3A;

FIG. 3D is a schematic top view of an electrically discontinuous region;

FIG. 4A is a top view of an electrode including first and second meshes;

FIG. 4B is a top view of the first mesh of the electrode of FIG. 4A;

FIG. 4C is a top view of a portion of the second mesh of the electrode of FIG. 4A;

FIG. 5 is a schematic top view of an electrode;

FIG. 6A is a top view of an electrode;

FIGS. 6B-6C are top views of portions of the electrode of FIG. 6A;

FIGS. 6D-6E are top views of portions of common boundaries of tiles of the electrode of FIG. 6A;

FIG. 7 is a top view of a common border between adjacent mesh tiles;

FIG. 8 is a top view of a common border between adjacent mesh tiles;

FIG. 9 is a schematic top view of a capacitive touch sensitive apparatus;

FIG. 10 is a top view of a Voronoi diagram;

FIG. 11 is a top view of a mesh tile;

FIG. 12 is a schematic top view of overlapping meshes; and

FIG. 13 is a top view of a closed cell.

### DETAILED DESCRIPTION

In the following description, reference is made to the accompanying drawings that forms a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

Electrodes may utilize a metallic mesh design where the mesh is a pattern geometry having connected traces that are arranged to form cells. Such electrodes have been found to be useful in a variety of applications such as in display and other applications where it is desired for light to be transmitted through the electrode. An illustrative example application of such electrodes is in touch sensors that overlay a viewable portion of a display. Metallic mesh electrodes and sensors or other components including the electrodes are described, for example, in U.S. Pat. No. 8,179,381 (Frey et al.), U.S. Pat. No. 8,274,494 (Frey et al.), U.S. Pat. No. 8,970,515 (Moran et al.), U.S. Pat. No. 8,933,906 (Frey), U.S. Pat. No. 9,320,136 (Frey et al.) and U.S. Pat. Pub. Nos. 2013/0299214 (Frey et al.) and 2013/0082970 (Frey et al.), each of which is hereby incorporated herein by reference to the extent that it does not contradict the present description. In display applications, it may be desired to randomize the mesh in order to avoid optical artifacts such as moiré resulting from interference patterns between the mesh and an array of pixels in the display. However, it is often desired from a manufacturing perspective to make the mesh using a continuous process in which the mesh pattern repeats regularly. In some aspects of the present description, meshes which simultaneously incorporate irregularity and a repeating characteristic are provided. In some embodiments, an electrically conductive mesh of an electrode includes a plurality of irregularly arranged vertices in a tile or grid cell, and the tile or grid cell regularly repeats in at least one direction. In some embodiments, the electrode is made by first defining a mesh tile and then regularly repeating the mesh tile. Such a tiled electrode can be divided into a plurality of same size and shape grid cells. The grid cells may correspond to the tiles used in defining the mesh, but other possible grid cells may be chosen. For example, the mesh tile used in constructing the electrode may be rectangular and the grid cells may include adjacent portions of two mesh tiles. A different mesh tile corresponding to the chosen grid cell could alternatively have been used to construct the electrode.

In some embodiments, the electrodes of the present description include a mesh of metallic traces disposed on a visible light transparent substrate. “Visible light transparent” refers to the level of transmission of the unpatterned substrate or of the electrode including a mesh disposed on the substrate being at least 60 percent transmissive to at least one polarization state of visible light, where the percent transmission is normalized to the intensity of the incident, optionally polarized light. It is within the meaning of visible light transparent for an article that transmits at least 60 percent of incident light to include microscopic features (e.g., dots, squares, or traces with minimum dimension, e.g. width, between 0.5 and 10 micrometers, between 0.5 and 5 micrometers, or between 1 and 5 micrometers) that block light locally to less than 60 percent transmission (e.g., 0 percent); however, in such cases, for an approximately equiaxed area including the microscopic feature and measuring 1000 times the minimum dimension of the microscopic feature in width, the average transmittance is greater than 60 percent. The term “visible” in connection with “visible light transparent” is modifying the term “light,” so as to specify the wavelength range of light for which the substrate or micropatterned article (e.g., metallic mesh on a substrate) is transparent (e.g., wavelengths from 400 nm to 700 nm).

The open area fraction (or open area or percentage of open area or open aperture) of a conductive mesh, or region of a conductive mesh, is the proportion of the mesh area or region area that is not shadowed by the conductor. The open area is equal to one minus the area fraction that is shadowed by the conductive mesh, and may be expressed conveniently, and interchangeably, as a decimal or a percentage. Area fraction that is shadowed by conductive mesh is used interchangeably with the density of lines or traces (e.g., non-linear traces) for a conductive mesh. Illustrative open area fraction values useful in the present description are those greater than 50%, greater than 75%, greater than 80%, greater than 90%, greater than 95%, greater than 96%, greater than 97%, greater than 98%, greater than 99%, 99.25 to 99.75%, 99.8%, 99.85%, 99.9% and even 99.95%. In some embodiments, the open area of a region of the conductive mesh (e.g., a visible light transparent conductive region) is between 80% and 99.5%, in other embodiments between 90% and 99.5%, in other embodiments between 95% and 99%, in other embodiments between 96% and 99.5%, in other embodiments between 97% and 98%, and in other embodiments up to 99.95%. In some embodiments, the traces of the conductive mesh have a width in the range of 0.1 to 20 micrometers, in some embodiments in the range of 0.5 to 10 micrometers, in some embodiments in the range of 0.5 to 5 micrometers, in some embodiments in the range of 0.5 to 4 micrometers, in some embodiments in the range of 0.5 to 3 micrometers, in some embodiments in the range of 0.5 to 2 micrometers, in some embodiments from 1 to 3 micrometers, and in some embodiments in the range of 0.1 to 0.5 micrometers.

In some embodiments, a mesh includes curved traces between adjacent vertices. In some embodiments, each of a majority (i.e., greater than 50 percent) of the traces is curved. In some embodiments, each of at least 60 percent, or at least 80 percent, or at least 90 percent of the traces is curved. In some embodiments, each of the traces is curved. In some embodiments, each of the traces (or each of a majority of the traces, each of at least 60 percent, or at least 80 percent, or at least 90 percent of the traces) has a radius of curvature of less than 1 cm, or less than 1 millimeter, or less than 500 micrometers. In some embodiments, each of the traces (or each of a majority of the traces, each of at least 60 percent, or at least 80 percent, or at least 90 percent of the traces) has a radius of curvature greater than 20 micrometers, or greater than 50 micrometers, or greater than 75 micrometers, or greater than 100 micrometers. In some embodiments, each of a majority (or at least 60 percent, or at least 80 percent, or at least 90 percent, or all) of the traces has a continuous first derivative along the entire length of the trace. The length of a straight line or linear trace is understood to mean the length between adjacent vertices spanned by the line or trace. The length of a curved trace refers to the length along the curve of the trace between adjacent vertices.

There are various equivalent ways of expressing the condition that a curve has a continuous first derivative that are familiar in the context of differential geometry. One way of expressing this condition is to specify a continuous parameter along the length of the curve (e.g., starting a zero at one end of the curve and ending a 1 at the other end of the curve) and then define the first derivative of the vector position along the curve from a reference point (e.g., a vector from an origin of a coordinate system) with respect to the parameter. If the first derivative of each component of the vector position is continuous, the curve may be said to have a continuous first derivative. For example, a circular arc spanning a quarter of a circle of radius R can be parameterized by (x(t), y(t))=(R sin(πt/2), R cos(πt/2)) for t ranging from 0 to 1. The first derivative of each of x(t) and y(t) with respect to the parameter t is continuous over the entire length of the arc. A curve may extend through a border and cross the border at a crossover point. The condition that the curve has a continuous first derivative at the crossover point can be expressed in terms of a continuous parameter along the length of the curve as described above. If the first derivative of each component of the vector position along the curve from a reference point with respect to the parameter at a parameter value corresponding to the crossover point is continuous, the curve may be said to have a continuous first derivative at the crossover point. Another way of describing a continuous first derivative at a crossover point on a border is to define a local x-y coordinate system near the crossover point with the x-axis orthogonal to the border at the crossover point and describe the curve, at least near the crossover point, in terms of a function y(x). If the derivative of y with respect to x is continuous at the crossover point, the first derivative at the crossover point may be said to be continuous. If a trace defines a curve (e.g., along a centerline of the trace) having a continuous first derivative along a length of the curve or at a crossover point, the trace may be said to have a continuous first derivative along the length of the trace or at the crossover point, respectively. Traces with a continuous first derivative along the entire length of the trace do not have kinks where the trace abruptly changes direction.

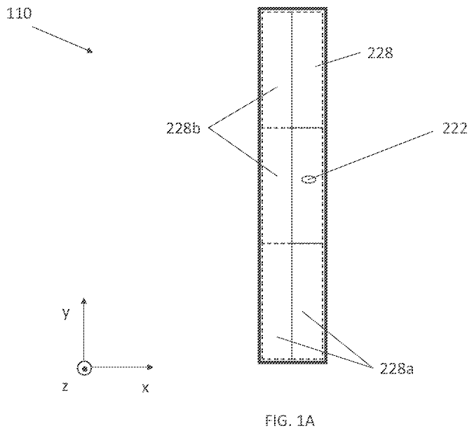

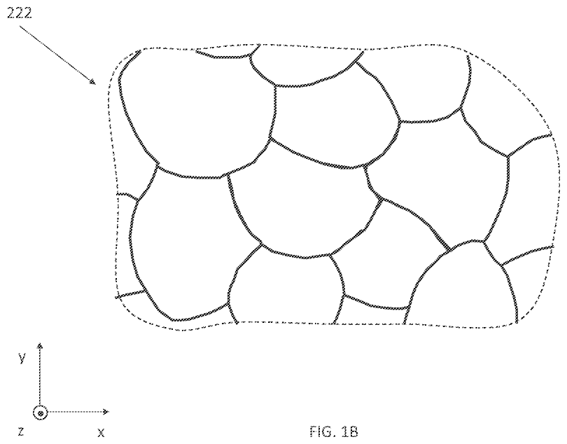

FIG. 1A is a schematic top view of electrode 110 including a plurality of tiles 228 which include a continuously electrically conductive mesh as described further elsewhere herein. An illustrative example of a region 222 of a tile is provided in FIG. 1B which is a schematic top view of the region 222 of a tile in which irregularly arranged vertices and curved traces between adjacent vertices are shown. In the illustrated embodiment, the tiles 228 repeat along both the x- and y-directions, referring to the x-y-z coordinate system of FIGS. 1A-1B. In other embodiments, the tiles repeat along only one direction or repeat along three or more different directions, where different directions refer to non-parallel directions. The plurality of tiles 228 include a first plurality of tiles 228a arranged in the x-direction and a second plurality of tiles 228b arranged in the y-direction. In some embodiments, the electrode 110 includes the plurality of tiles 228 and in addition includes portions of other tiles along one or both edges or along one or both ends. For example, in some embodiments, a length or width of the electrode may not be an integer multiple of a length or a width of the tile so that a portion of the electrode at the end(s) and/or edge(s) of the electrode includes only portions of tiles. In some embodiments, the electrode 110 can be divided into a plurality of same size and shape grid cells (e.g., corresponding to tiles 228) forming a continuous two-dimensional grid. In some embodiments, the continuous two-dimensional grid spans an entire area of the electrode. In other embodiments, the continuous two-dimensional grid spans a portion of the electrode (e.g., at least 60 percent, or at least 80 percent, or at least 90 percent of the area of the electrode). For example, in some embodiments, a length or width of the electrode may not be an integer multiple of a grid cell size so that a portion of the electrode at the end(s) and/or edge(s) of the electrode includes only a portion of a grid cell. In this case, the mesh of the electrode can be divided into a plurality of same size and shape grid cells forming a continuous two-dimensional grid spanning all but the end and/or edge portion(s) of the electrode which may be covered by portions of the grid cells. In the illustrated embodiment, the grid is a rectangular grid. In some embodiments, the grid is a square grid (which can be understood to be a special case of a rectangular grid) or a hexagonal grid, for example.

In some embodiments, each tile or grid cell of an electrode has a same size and shape. In other embodiments, the electrode may be tiled by two or more different tiles or grid cells having different sizes and/or shapes. For example, every other one of the rectangular tiles 228 may be substituted with two shorter rectangular tiles and the electrode would then be tiled by a combination of the original rectangular tiles 228 and the shorter rectangular tiles.

A mesh may be said to include repeating tiles or grid cells even if the each of the tiles or grid cells are not identical. For example, each tile or grid cell may be nominally the same, but ordinary manufacturing variations can result in minor differences in the tiles or grid cells and the mesh would still be described as including repeating tiles or grid cells. Other minor differences between tiles and grid cells may also be present in a repeating pattern. The strength of a repeating pattern of tiles or grid cells in a mesh can be quantified in terms of the Fourier transform of the positions of the vertices in the mesh. If the Fourier transform has substantial peaks corresponding to the repeating pattern, the mesh may be described as repeating even if the Fourier transform is not exactly zero between the peaks.

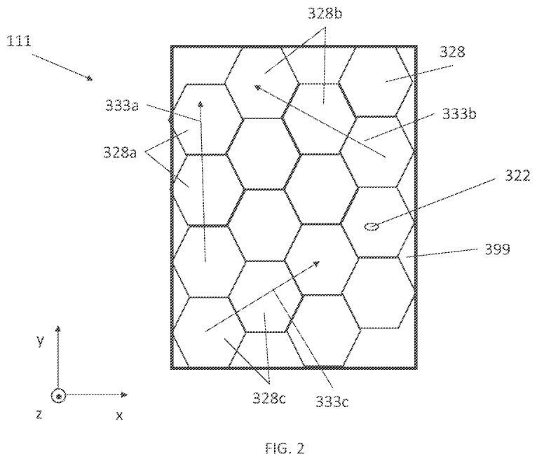

The tiles may repeat in more than two different directions. FIG. 2 is a schematic top view of electrode 111 including a plurality of tiles 328 which include a continuously electrically conductive mesh as described further elsewhere herein. The tiles 328 repeat along different first, second and third non-parallel directions 333a, 333b and 333c. The tiles 328 include first, second and third pluralities of tiles 328a, 328b and 328c that repeats along the different first, second and third directions 333a, 333b and 333c. The mesh of electrode 111 can be divided into a plurality of same size and shape grid cells (corresponding to tiles 328) forming a continuous two-dimensional grid, which in the illustrated embodiment is a hexagonal grid. A region 322 of the electrode 111 may appear, for example, as illustrated in FIG. 1B for region 222, or may include other mesh patterns described elsewhere herein. Electrode 111 may also include regions 399 along side(s) or edge(s) of the electrode 111 which include mesh that is not part of the plurality of tiles 328. In some embodiments, the regions 399 include portions of a tile or grid cell.

In some embodiments, individual electrodes are made using mesh tiles and the methods described further elsewhere herein. In other embodiments, an array of electrodes may be made using tiles that define both the continuously electrically conductive mesh of the electrode and electrically non-conductive regions between adjacent electrodes.

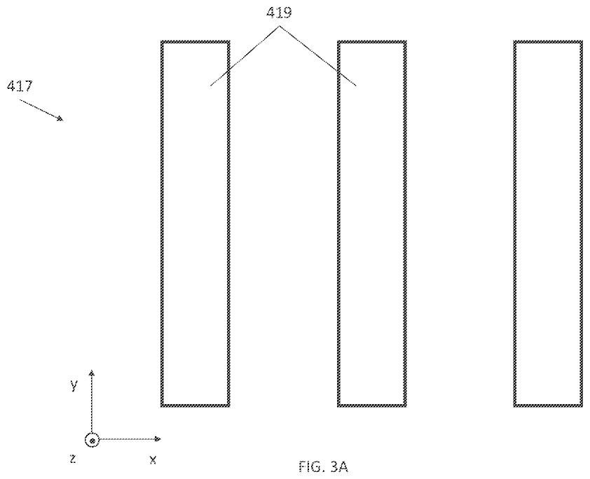

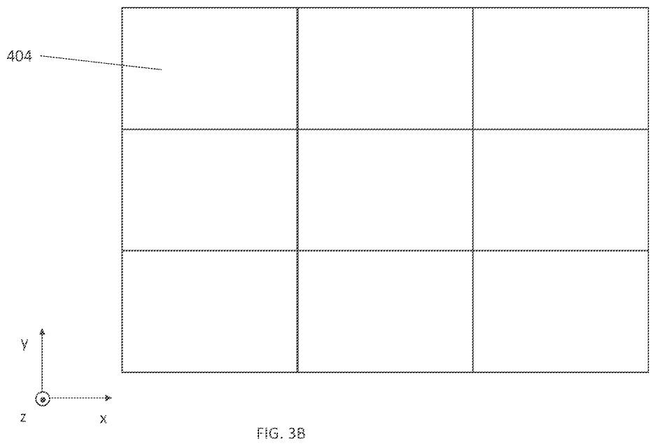

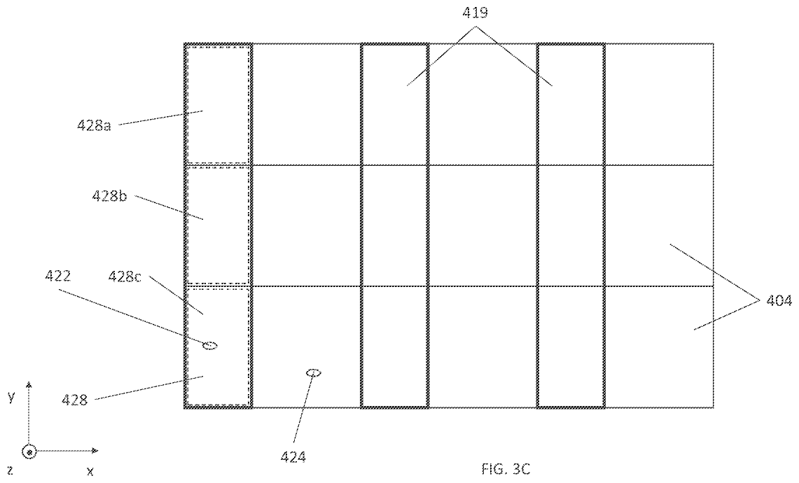

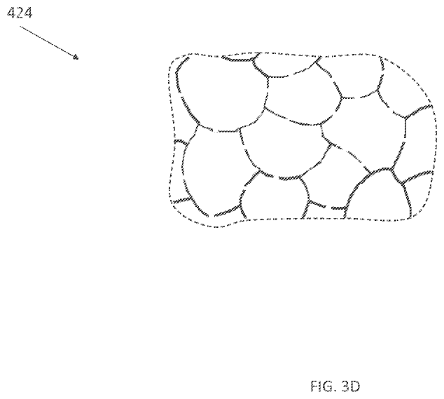

FIG. 3A is a schematic top view of an array 417 of electrodes 419. FIG. 3B is a schematic top view of mesh tiles 404 which are arranged in a two-dimensional grid in the x-y plane in the illustrated embodiment, though other arrangements may be used. FIG. 3C is a schematic top view of mesh tiles 404 and the array 417 of electrodes 419. In some embodiments, the array 417 of electrodes 419 is formed from using the mesh tiles 404. In some embodiments, the mesh tiles 404 define continuously electrically conductive regions 422 of the electrodes 419 and electrically discontinuous regions 424 between adjacent electrodes 419. The overlap of the mesh tiles 404 with the electrodes 419 defines tiles 428. In some embodiments, each electrode 419 is a continuously electrically conductive tiled electrode including a plurality of tiles 428 arranged along a first direction (y-direction) and including a plurality of pairs of adjacent tiles (e.g., the pair of tiles 428a and 428b, and the pair of tiles 428b and 428c).

The continuously electrically conductive regions 422 may appear, for example, as illustrated in FIG. 1B for region 222 or may include other mesh patterns described elsewhere herein. FIG. 3D is a schematic top view of an illustrative example of an electrically discontinuous region 424. Here, traces includes breaks which render the mesh in this region non-conductive. In some embodiments, each of the traces includes a break and in other embodiments, not all of the traces includes a break. Utilizing electrically discontinuous regions between adjacent electrodes has been found to reduce optical artifacts associated with a boundary of the electrodes when it overlays a display.

In the illustrated embodiment, each of the tiles 404 covers a width of one of the electrically conductive electrodes 419 and covers a width of one discontinuous region between adjacent electrodes. In other embodiments, other portions of the array of electrodes may be defined by the mesh tiles. For example, a single mesh tile may cover the width of two or more electrodes and of two or more regions between adjacent electrodes. In other embodiments, one set of tiles (e.g., tiles 428) is used to define the electrodes and another set of tiles is used to define the regions between adjacent electrodes (e.g., tiles corresponding to the portions of tiles 404 not overlapping with tiles 428).

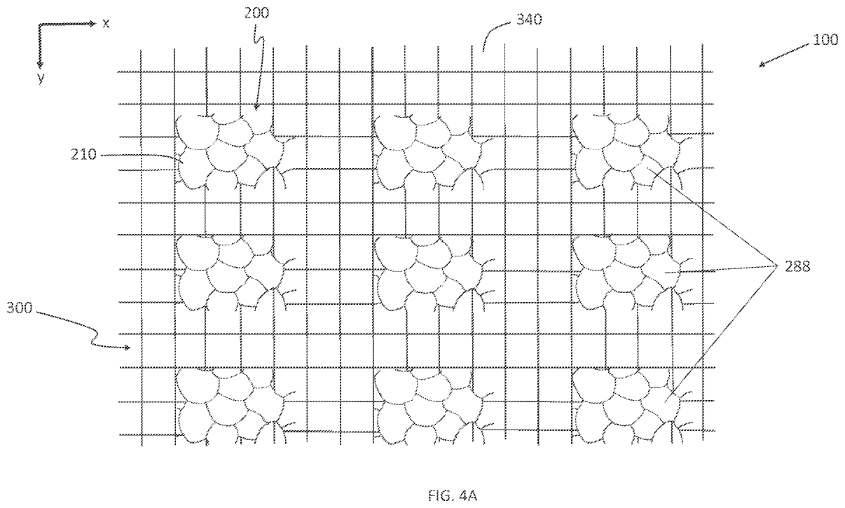

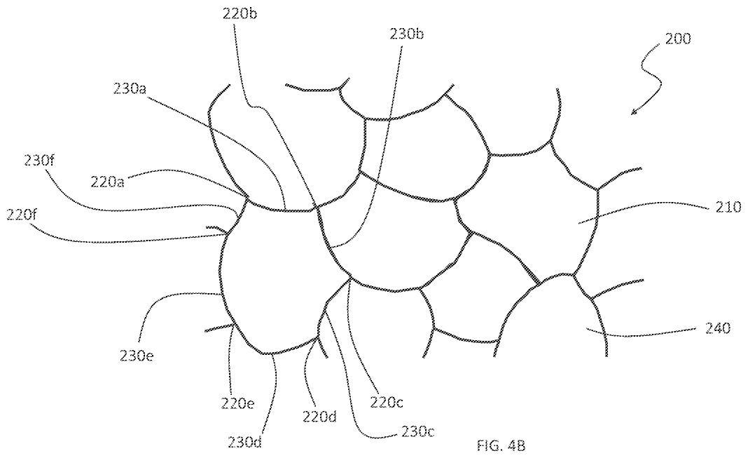

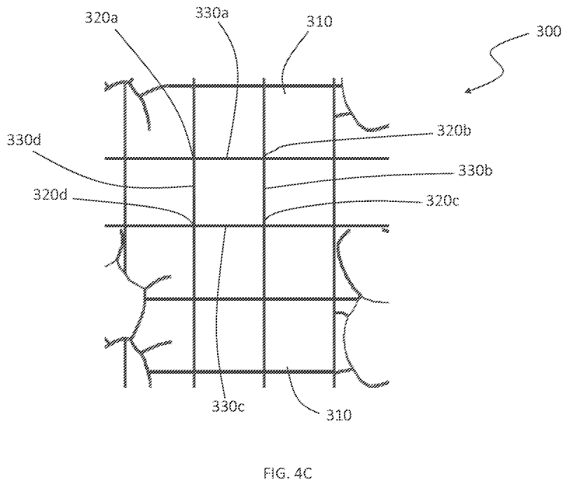

FIG. 4A is a top view of a continuously electrically conductive electrode 100 including an electrically conductive first mesh 200 repeating across the electrode to form a two-dimensional regular array 288 of the first mesh, and including an electrically conductive second mesh 300 different from the first mesh 200. FIG. 4B is a top view of the first mesh 200 and FIG. 4C is a top view of a portion of the second mesh 300. The first mesh 200 includes a plurality of conductive closed cells 210. Each of the closed cells 210 includes a plurality of vertices 220a-220f connecting a plurality of electrically conductive traces 230a-230f. The electrically conductive second mesh 300 includes a plurality of conductive closed cells 310. Each closed cell 310 includes a plurality of vertices 320a-320d connecting a plurality of electrically conductive traces 330a-330d. In some embodiments, the vertices in the plurality of vertices in each cell for at least one of the first and second meshes are irregularly arranged. In the illustrated embodiment, the vertices 220a-220f in each closed cell 210 are irregularly arranged and the vertices 320a-320d in each closed cell 310 are regularly arranged. In other embodiments, the vertices 220a-220f of the first mesh 200 and the vertices 320a-320d of the second mesh 300 are irregularly arranged, or the vertices 220a-220f of the first mesh 200 are regularly arranged and the vertices 320a-320d of the second mesh 300 are irregularly arranged.

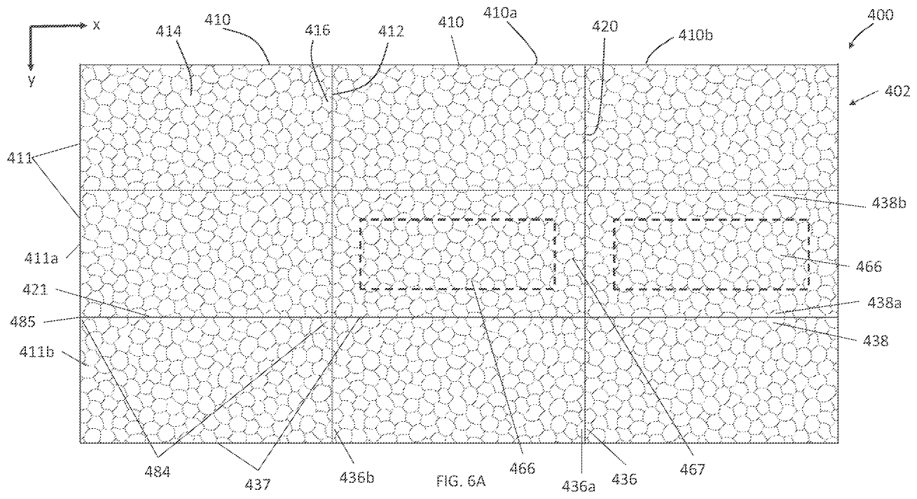

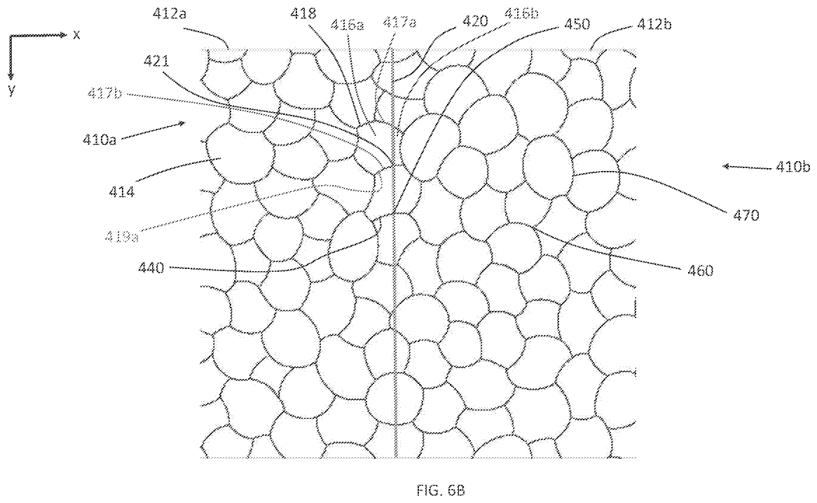

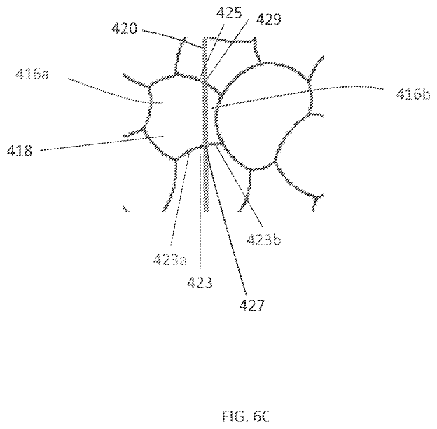

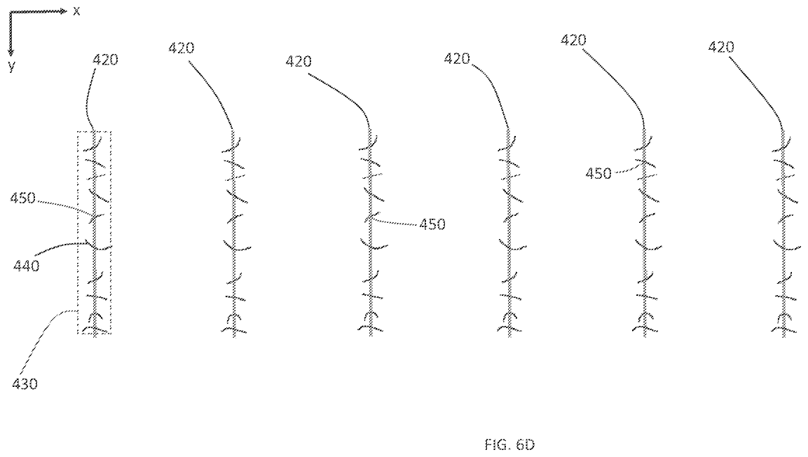

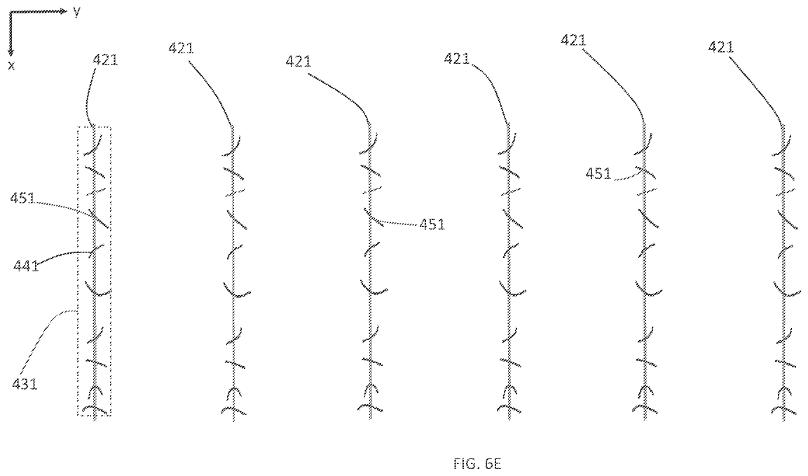

In other embodiments, the second mesh 300 may be omitted and a continuously electrically conductive electrode may include a first mesh 200 repeating across the electrode to form a two-dimensional regular array of the first mesh where adjacent instances of the first mesh 200 contact each other and the array is directly electrically interconnected. For example, in some embodiments, each first mesh in the array of the first mesh shares a common border with an adjacent first mesh in the array of the first mesh such that at least one open cell in the first mesh combines with an open cell in the adjacent first mesh along the common border to form a combined closed cell (see, e.g., FIG. 6C).

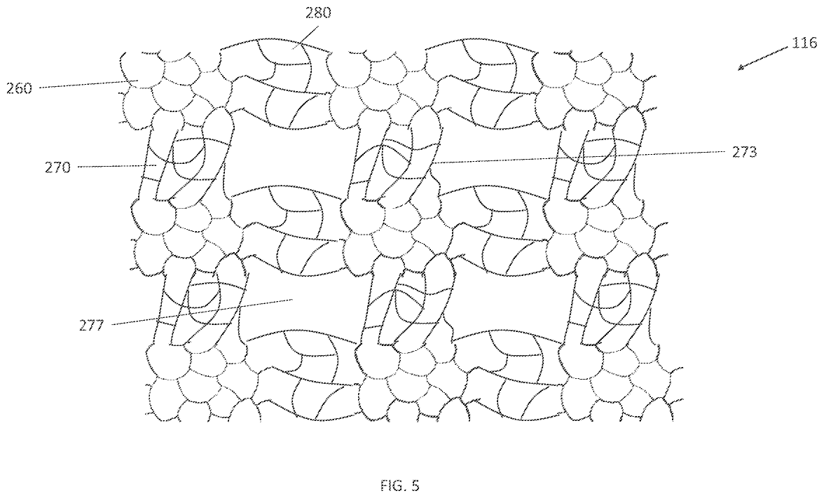

In other embodiments, a continuously electrically conductive electrode includes more than two meshes. FIG. 5 is a top view of electrode 116 including first, second, third and fourth meshes 260, 270, 273 and 280, respectively. In the illustrated embodiment, each of the first, second, third and fourth meshes 260, 270, 273 and 280 repeats to form a two-dimensional regular array of the respective mesh. In some embodiments, any one or more of the two-dimensional regular arrays is a rectangular array, a square array (which can be understood to be a special case of a rectangular array), or a hexagonal array. For example, in the illustrated embodiment, the first mesh 260 repeats to form an approximately square array of the first mesh 260. In some embodiments, at least one of the first, second, third and fourth meshes 260, 270, 273 and 280 includes closed cells having a plurality of vertices that are irregularly arranged. In the illustrated embodiment, each of the first, second, third and fourth meshes 260, 270, 273 and 280 has irregularly arranged vertices. In the illustrated embodiment, open regions 277 in which there is no mesh is included. In other embodiments, the open regions 277 is filled with a fifth mesh (not illustrated). Since the electrode 116 is conductive without this fifth mesh, in some embodiments, the fifth mesh is electrically disconnected from the first, second, third and fourth meshes 260, 270, 273 and 280. In other embodiments, the fifth mesh is electrically connected to at least the second, third and fourth meshes 270, 273 and 280. In this case, the union of the second, third and fourth meshes 270, 273 and 280 and the fifth mesh may be described as a mesh and the resulting electrode may be described as including a first mesh 260 repeating across the electrode to form a two-dimensional regular array of the first mesh 260, and an electrically conductive second mesh (being the union of the second, third and fourth meshes 270, 273 and 280 and the fifth mesh) different from the first mesh 260.

FIG. 6A is a top view of a continuously electrically conductive tiled electrode 400. FIGS. 6B-6C are top views of portions of the tiled electrode 400. Electrode 400 includes a first plurality of tiles 410 arranged along a first direction (x-direction) and includes a first plurality of pairs of adjacent tiles, such that each pair of adjacent tiles 410a, 410b in the first plurality of adjacent tiles comprises a common border 420 and a same plurality 430 of irregularly arranged electrically conductive traces 440 with each conductive trace extending across the common border 420 (illustrated in FIG. 6D) at a crossover point 450 and having a continuous first derivative at the crossover point 450. In other words, the border 420 and the plurality 430 of irregularly arranged electrically conductive traces 440 are repeated in the first direction so that every border 420 between adjacent tiles in the first plurality of tiles 410 is the same as every other border 420 and includes the same plurality 430 of irregularly arranged electrically conductive traces 440. The traces 440 have a continuous first derivative at the crossover point 450 so that there is no kink where the traces abruptly change direction at the crossover point 450.

In the illustrated embodiment, electrode 400 further includes a second plurality of tiles 411 arranged along a second direction (y-direction) different from the first direction and includes a second plurality of pairs of adjacent tiles, such that each pair of adjacent tiles 411a, 411b in the second plurality of adjacent tiles comprises a common border 421 and a same plurality 431 of irregularly arranged electrically conductive traces 441 with each conductive trace extending across the common border 421 (illustrated in FIG. 6E—note that the common border 420 illustrated in FIG. 6D extends in the y-direction, while the common border 421 illustrated in FIG. 6E extends in the x-direction) at a crossover point 451 and having a continuous first derivative at the crossover point 451.

The first and second pluralities of tiles 410 and 411 may be arranged on a rectangular grid as illustrated, or may be arranged on a square grid (which can be understood to be a special case of a rectangular grid), or may be arranged on a hexagonal grid (see, e.g., FIG. 2), for examples. In some embodiments, the electrode further includes a third plurality of tiles arranged along a third direction (e.g., third direction 333c) different from the first and second directions and includes a second plurality of pairs of adjacent tiles (e.g., adjacent tiles 328c), such that each pair of adjacent tiles in the third plurality of adjacent tiles comprises a common border and a same plurality of irregularly arranged electrically conductive traces with each conductive trace extending across the common border at a crossover point and having a continuous first derivative at the crossover point (e.g., a common border between adjacent tiles 328c may appear as common borders 420 or 421 in FIG. 6D or 6E).

In some embodiments, the continuously electrically conductive mesh 402 of electrode 400 includes a plurality of vertices 460 connecting a plurality of electrically conductive traces 470, such that the mesh 402 can be divided into a plurality of same size and shape grid cells 437 forming a continuous two-dimensional grid. In some such embodiments, a perimeter 412 of each grid cell intersects a plurality of irregularly arranged electrically conductive traces in the plurality of electrically conductive traces 440 without passing through any vertex 460 in the mesh 402. In some embodiments, the grid cells 437 correspond the tiles 410 and 411. In other embodiments, the grid cells 437 may be taken to be cells that do not correspond to the mesh tiles used to define the conductive mesh 402 of the electrode (e.g., a grid cell may be taken to be half of two adjacent tiles).

In some embodiments, a mesh tile (e.g., tile 410a) is configured to be repeatedly tiled along at least a first direction (e.g., x-direction, y-direction, or both) to form a continuous tiled mesh 402. The mesh tile includes a perimeter 412; a plurality of closed cells 414 within and away from the perimeter 412, each closed cell 414 including a plurality of vertices (see, e.g., vertices 220a-220f) connecting a plurality of traces (see, e.g., traces 230a-230f); and a plurality of open cells 416 along the perimeter 412, each open cell 416 including at least one trace (e.g., traces 417a and 417b) terminating at the perimeter 412, such that when the mesh tile is repeatedly tiled along at least a first direction (e.g., x-direction and/or y-direction) to form a tiled mesh 402 along the at least first direction, for each pair of adjacent mesh tiles (e.g., adjacent tiles 410a and 410b) having portions 412a and 412b of the perimeters thereof overlapping each other to form a common border 420 of the adjacent mesh tiles, each of at least a plurality of pairs of corresponding open cells 416a and 416b at the common border 420 in the adjacent mesh tiles combine to form a corresponding combined closed cell 418. In some embodiments, for each of at least a plurality of combined closed cells, the combined closed cell includes a plurality of irregularly arranged vertices. Traces of open cells which meet at a common border may also combine to form a combined trace. For example, referring to FIG. 6C, open cell 416a includes a trace 423a terminating at the common border 420; open cell 416b includes a trace 423b terminating at the common border 420; and the traces 423a and 423b combine to form a combined trace 423. The trace 423 has a continuous first derivative where it crosses the common border 420 at a crossover point 427. In some embodiments, the combined closed cell 418 includes at least one trace (423 and 425) extending across the common border at a crossover point (427 and 429, respectively) and having a continuous first derivative at the crossover point.

In some embodiments, a mesh tile (e.g., tile 410a) is configured to be repeatedly tiled along at least a first direction (x- and/or y-directions) to form a continuous tiled mesh 402. The mesh tile includes a perimeter 412; a plurality of closed cells 414 within and away from the perimeter, each closed cell including a plurality of vertices (see, e.g., vertices 220a-220f) connecting a plurality of traces (see, e.g., traces 230a-230f); and a plurality of open cells 416 along the perimeter 412. In some embodiments, each open cell in the plurality of open cells 416 includes at least one trace (e.g., trace 417a and 417b) terminating at the perimeter 412, such that for each first open cell in the plurality of open cells 416 along the perimeter 412, there is a different second open cell in the plurality of open cells 416 along the perimeter that when translated linearly along at least one direction, combines with the first open cell to form a combined closed cell including a plurality of irregularly arranged vertices. For example, when second open cell 436b, which is along the perimeter 412, is translated linearly along the x-direction, it combines with the first open cell 436a to form a combined closed cell 436. Similarly, when fourth open cell 438b, which is along the perimeter 412, is translated linearly along the y-direction, it combines with the third open cell 438a to form a combined closed cell 438.

In some embodiments, in addition to the plurality of open cells 416 along the perimeter 412, there is a second plurality of open cells 484 at corners 485 of the perimeter 412. For example, in some embodiments the mesh tile is rectangular and includes four corner open cells in the second plurality of open cells 484 in addition to the plurality of open cells 416 along the sides of the rectangle. In some embodiments, when a first corner cell in the second plurality of open cells 484 is translated in the x-direction, a second corner cell in the second plurality of open cells 484 is translated in the y-direction, and a third corner cell in the second plurality of open cells 484 is translated in the x and y-directions, the first, second and third corner open cells combine with a fourth corner open cell to form a combined closed cell. The number of open cells at or near a corner that needs to be translated to form a combined closed cell can depend on the geometry of the tile near the corners. For example, in some embodiments one combined closed cell at or near a corner is formed from 3 open cells and another combined closed cell at or near a corner is formed from 4 open cells.

The continuously electrically conductive tiled electrode 400 can also be described in terms of a first mesh 466 which is an interior portion of the tiles (e.g., tile 410a) of the tiled electrode 400. In the illustrated embodiment, the first mesh 466 repeats across the tiled electrode 400 to form a two-dimensional regular array of the first mesh. Two instances of the first mesh 466 are outlined in FIG. 6A, but it will be understood that each mesh tile in the tiled electrode includes an instance of the first mesh 466. The mesh of the tiled electrode 400 between instances of the first mesh 466 is a second mesh 467 which electrically interconnects the array of the first mesh 466. In some embodiments, the tiled electrode 400 is a continuously electrically conductive electrode including an electrically conductive first mesh 466 repeating across the electrode 400 to form a two-dimensional regular array of the first mesh 466, where the first mesh 466 includes plurality of conductive closed cells with each closed cell including a plurality of vertices connecting a plurality of electrically conductive traces; and including an electrically conductive second mesh 467 different from the first mesh 466 and including a plurality of conductive closed cells with each closed cell including a plurality of vertices connecting a plurality of electrically conductive traces. In the illustrated embodiment, the vertices in the plurality of vertices in each closed cell for each of the first and second meshes 466 and 467 are irregularly arranged. In other embodiments, only one or the other of the first and second meshes have irregularly arranged vertices as described further elsewhere herein.

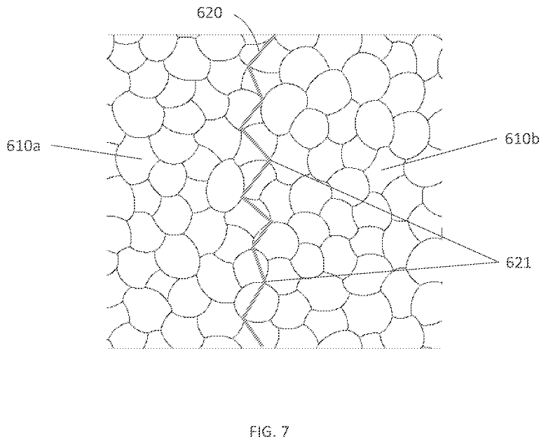

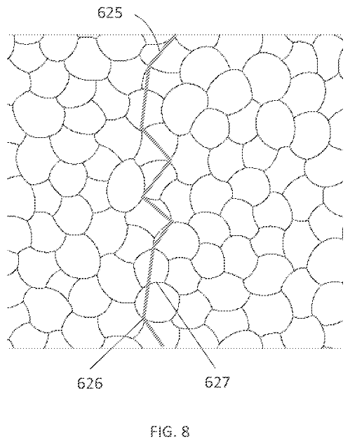

In the embodiment illustrated in FIGS. 6A-6E, the tiles 410 and corresponding grid cells 437 are arranged relative to the mesh such that the border pass through traces without intersecting any vertices. In other embodiments, the tiles or grid cells may have a perimeter which intersects one or more vertices. Since the mesh is periodic, an alternative set of tiles or grid cells can be obtained by altering each perimeter to include one or more vertices. This is illustrated in FIG. 7 which shows a common border 620 between adjacent mesh tiles 610a and 610b that includes vertices 621. In the illustrated embodiment, the common border 620 intersects traces only at the vertices 621. In other embodiments, the common border intersects at least one vertex and intersects at least one trace at a crossover point such that the trace has a continuous first derivative at the crossover point. This is illustrated in FIG. 8 which shows a common border 625 intersecting a vertex 626 and intersecting a trace 627 at a crossover point where the trace has a continuous first derivative at the crossover point.

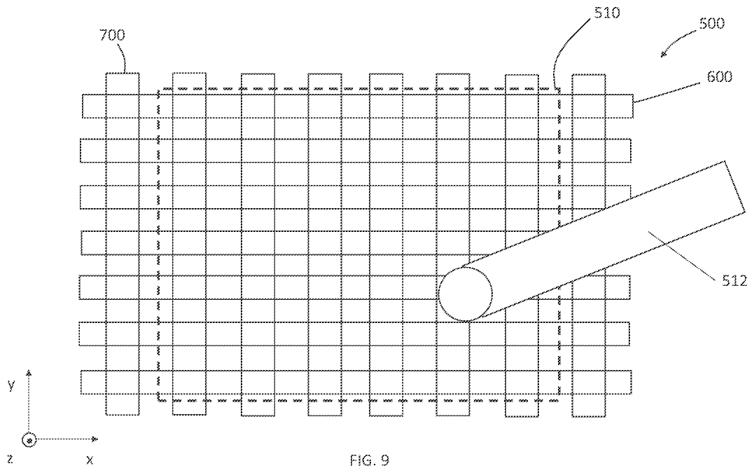

FIG. 9 is a schematic top view of a capacitive touch sensitive apparatus 500. In some embodiments, the capacitive touch sensitive apparatus 500 is configured to detect a location of an applied touch (e.g., of an object 512 such as a finger or a stylus) by detecting a change in a coupling capacitance (also referred to as mutual capacitance). The touch sensitive apparatus 500 includes a touch sensitive viewing area 510; a plurality of spaced apart electrically conductive first electrodes 600 disposed in the touch sensitive viewing area 510 and extending along a first direction (x-direction in the illustrated embodiment); and a plurality of spaced apart electrically conductive second electrodes 700 disposed in the touch sensitive viewing area 510 and extending along a different second direction (y-direction in the illustrated embodiment). At least one of the first and second electrodes 600 and 700 includes an electrically conductive first mesh (e.g., first mesh 200 or first mesh 466) repeating across the electrode to form a regular array of the first mesh, the first mesh including a plurality of conductive closed cells (e.g., closed cells 210), each closed cell including a plurality of irregularly arranged vertices (e.g., vertices 220a-220f) connecting a plurality of electrically conductive traces (e.g., traces 230a-230f).

Capacitive touch sensitive devices including first electrodes extending in a first direction and second electrodes extending in a second direction are known. The first electrodes extending in the first direction and the second electrodes extending in the second direction may be spaced apart from one another in a third direction (the z-direction of FIG. 9) with a dielectric layer therebetween. A controller or microprocessor or the like may be electrically connected to the first and second electrodes and configured to determine a change in a coupling capacitance when the capacitive touch sensitive device is touched. Two or more conductor patterns that are overlaid can be generated by laminating two substrates together with a clear adhesive, where each substrate has disposed on one its major surfaces a conductive mesh according to the present description. Such laminated articles can be visible light transparent when the substrates are transparent and when the conductive mesh has high open area fraction. Examples of suitable substrates for forming laminated constructions include polyester films (e.g., polyethylene terephthalate (PET) films) and triacetate (TAC) films.

Examples of suitable adhesive materials for forming laminated constructions are optically clear adhesive that exhibit an optical transmission of at least about 90%, or even higher, and a haze value of below about 5%, or even lower. Optical transmission and haze can be measured by disposing it between a 25 micrometer MELINEX polyester film 454 (from DuPont Company, Wilmington, Del.) and a A 75×50 millimeter plain micro slide (a glass slide from Dow Corning, Midland, Mich.) using a Model 9970 BYK Gardner TCS Plus Spectrophotometer (from BYK Gardner, Columbia, Md.). Suitable optically clear adhesive may have antistatic properties, is compatible with metal-based conductors, may be able to be released from the glass substrate by stretching the adhesive described in Illustrative optically adhesive include those described in PCT International Publication No. WO 2008/128073 relating to antistatic optically pressure sensitive adhesive, U.S. Patent Application Publication Nos. US 2009-030084 A1 relating to stretch releasing optically clear pressure sensitive adhesive, US 2010-0028564 A1 relating to antistatic optical constructions having optically transmissive adhesive, PCT International Publication Nos. WO 2009/114683 relating to optically clear stretch release adhesive tape, WO 2010/019528 relating to adhesives compatible with corrosion sensitive layers, and WO 2010/078346 stretch release adhesive tape. In one embodiment, the optically clear adhesive has a thickness of about 5 micrometers or less.

A substrate having the conductive mesh disposed thereon, or alternatively a laminate including two or more substrates having the conductive meshes disposed thereon, can be further laminated to a display, for example a liquid crystal display (LCD), an organic light-emitting diode (OLED) display, a plasma display panel (PDP), an electophoretic display (EP), or an electrowetting display. Such a substrate or laminate can be laminated to the display using the referenced adhesive materials. A substrate having the conductive mesh disposed thereon, or alternatively a laminate including two or more substrates having the conductive meshes disposed thereon, can be further laminated to another material, for example a rigid support such as a thick (e.g., 1 millimeter) polymer sheet or glass sheet. Examples of rigid supports include the screens of mobile handheld devices such as mobile phones or smart phones.

In some embodiments, a conductive mesh as described herein is disposed on more than one side of a substrate, for example on each major surface of a flat substrate that may be flexible or rigid. For applications that require two conductive meshes that are spaced apart in the direction normal to the meshes, it may be advantageous for the two meshes to be disposed on each side of the same flat substrate, for example on each side of a polymer film.

In some embodiments, a conductive mesh as described herein is disposed on a functional substrate. A functional substrate is a substrate that serves one or more specific purposes beyond the support of the conductive mesh, transmission of light, and basic mechanical continuity of the device into which the conductive mesh is integrated. Examples of functional substrates include linear polarizers (e.g., polymeric linear polarizer films), circular polarizers (e.g., polymeric circular polarizer films), antiglare layers (e.g., polymeric film or glass), display module substrates (e.g., bottom-emitting OLED cell substrates), scratch-resistant cover films, and light management films.

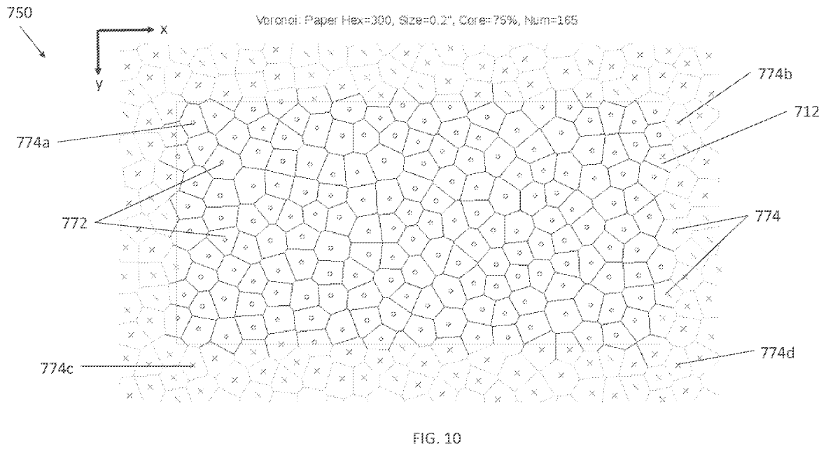

One method of designing a mesh involves utilizing a Voronoi diagram. A Voronoi diagram, also known as a Voronoi tessellation, is a mathematical term referring to a partitioning of a plane into regions based on distance to points in the plane referred to as seed points. Once the seed points are specified, a region corresponding to the seed point can be defined as the set of points in the plane closer to the specified seed point than to any of the other seed points. For a suitable selection of seed points, the boundaries between the regions of a Voronoi diagram can be used as a step in designing a mesh tile configured to be repeatedly tiled along at least a first direction to form a continuous tiled mesh. An example Voronoi diagram is illustrated in FIG. 10.

FIG. 10 is a top view of Voronoi diagram 750 including a perimeter 712 defining a tile. A plurality of seed points 772 are disposed within perimeter 712 and a plurality of periodic copies 774 of the seed points 772 are disposed around perimeter 712. For example, periodic copy 774b can be obtained from seed point 774a by translating seed point 774a by a translation distance in the x-direction (e.g., the width of the tile in the x-direction). Periodic copies 774c and 774d of seed point 774a are also illustrated in FIG. 10.

A tile containing a mesh pattern can be designed as follows. First select a size and a shape of the tile and an average cell size S and average cell area A. As an illustrative example, an array of the tiles may be used to replace a hexagonal mesh having a center to center distance of H, and a square tile having a width of 100 H, a length of 100 H and an average sell size S=H may be chosen. In other embodiments, a rectangular tile having a length and a width independently in a range of 20 H to 500 H is used. Other sizes and shapes (e.g., hexagons) of the tiles may be used. From the size of the tile and the average cell size, a desired number of seed points is calculated. For example, the desired number of seed points may be determined as the area of the tile divided by the average cell area A.

Next, the calculated number of seed points are placed into the tile. This can be done one point at a time, while imposing several constraints on the locations of the seed points. The constraints may be specified in relation to the previous points in the tile and to periodic copies of the previous points (the periodic copies correspond to the previous points that appear in adjacent tiles when a plurality of the tiles are arranged together with common boundaries between adjacent tiles). A suitable constraint is that each new point is at least 75% of the distance S away from all the previous points and at least 75% of the distance S away from all periodic copies of the previous points, for example. A Voronoi diagram constructed using such a specified minimum distance may be referred to as a hard-core Voronoi diagram. Such diagrams may be characterized by a core size as a percent of the distance S. For example, a Voronoi diagram constructed using seed points constrained such that each new point is at least 75% of the distance S away from all the previous points and at least 75% of the distance S away from all periodic copies of the previous points, may be referred to as a hard-core Voronoi diagram with a core of 75 percent. Other core values (e.g., a core percent in a range of 60 to 80 percent) may alternatively be used. However, it has been found that using a core of about 75 percent, results in a preferred aesthetic appearance.

Other methods for generating the seed points can be used. For example, seed points can be placed randomly (e.g. with low, even zero, core percent values) but then moved according to a suitable artificial repulsive force between points. The force can be modeled by many different types of functions; for example, one divided by the distance between points squared. Points can thus be moved a small distance each iteration until they are all in equilibrium or they could be moved less depending on the aesthetics desired. Alternatively, a field function could be defined over the tile, starting with zero or small random values and as points are added in sequence, values can be added to the field which are high at the location of the new point and drop off as one moves away from the point (for example, as one divided by the distance squared). Each subsequent point can then be placed at the then current minimum of the field function. Combinations of these methods could be used as well.

Next, a Voronoi diagram is constructed from the seed points in the tile and the periodic copies of the seed points. The boundaries between the regions of the Voronoi diagram define line segments between adjacent vertices of a mesh pattern. This is illustrated in FIG. 10, for example.

Next, the mesh pattern defined by the Voronoi diagram can be modified to spread the vertices out to reduce the number of short line segments. In one method, all vertices are moved toward the average position of their connecting vertices (i.e., those vertices to which a vertex is connected by a line segment). This step may be iterated. The amount that that the vertices are moved and how many times this step is iterated can be varied. In some embodiments, the vertices are moved a distance of 20 percent (or 10 percent, or 25 percent) of the distance to the previous average position of their connecting vertices in each step. In some embodiments, two (or 2-10) such steps are utilized, for example. In another method, only vertices connecting to at least one short edge or line segment (e.g., having a distance between connecting vertices less than a specified threshold) are moved toward the average position of their connecting vertices. In this method, the distance moved and the number of iterations may also be varied. In some embodiments, a combination of the two methods is used. For example, in some embodiments, in a first step all vertices are moved and in a second step only vertices connecting to at least one short edge are moved. In addition to the amount moved and the number of iterations used, another parameter that can be specified is the minimum length of the line segments. The vertices may be moved until all line segments between adjacent vertices have a length greater than the specified minimum length. For example, the minimum length may be specified as 0.2 times S, and using 20% of S for the minimum length, a vertex movement of 10 percent of the previous distance to the average position of their connecting vertices, and an unlimited iterations, for example, has been found to eliminate all edges shorter than the minimum length in typically 5 to 10 iterations.

Alternatively, the vertex positions could be adjusted considering not just making short edges longer, but also moving vertices to equalize the polygonal areas of the cells. Additionally, vertices could be moved in order for angles formed at vertices to be closer to 120 degrees, for example. The vertices can be moved for these three attributes (short edges longer, equalizing the polygonal areas, and adjusting angles at vertices to be closed to 120 degrees), or for a subset of these three attributes, iterating first for one attribute, then for the second, and finally for the third. In other embodiments, additional desired attributes are specified and the vertices are moved for more than these three attributes. Alternatively, the vertex movements could be iterated once for each attribute and then the sequence repeated a number of times. As another alternative, each of the previous three attributes can be weighted and the vertices moved in directions according to the weighted sum of all three “forces” every iteration.

The Voronoi diagram technique is useful for generating an irregular arrangement of vertices in a tile that is configured to be arranged periodically. Other techniques may also be used. For example, any number of regular or semi-regular periodic tessellations where some vertices connect more than three lines, e.g. a square lattice, can be used as an initial diagram. Each of the vertices connecting more than three lines, or a subset of these vertices (e.g., randomly selected), can be replaced with two new vertices with a line between the two vertices and each of the two vertices connecting at least two of the lines which were connected to the original vertex. The two new vertices can be spaced apart in a random direction, for example, to give an irregular grid. In some embodiments, the starting diagram is a square lattice and this vertex splitting technique results in an irregular grid with polygons having 4 to 8 edges.

Next, in some embodiments, the straight line segments are replaced with curves. The curves can be circular arcs or other curved shapes. The direction of the curve (e.g., bowed toward the left or right, relative to a viewing orientation) may be random. The replacement of a straight line segment with a curve may be carried out with the endpoint vertices remaining fixed. The amount of curvature can be varied among curves within a tile. The amount of curvature can be randomly distributed among curves within a tile. The amount of curvature can be randomly distributed over a range of curvatures. One method for adjusting the amount of curvature of a curve that replaces a straight line segment includes selecting a non-zero angle between the straight line segment and the curve at the vertex, for each vertex that terminates the straight line segment. As will be understood, increasing the angle leads to increased curvature (smaller radius of curvature). The actual curvature (or radius of curvature), for a circular curve (arc) is determined by the distance between the vertices and the angle, as is understood from geometry. For a tile comprising a plurality of closed cells, the aforementioned angle can be over a range of angles. In some embodiments, this range of angles is from 10 degrees, or 12 degrees or 15 degrees to 20 degrees, or 30 degrees, or 35 degrees, or 40 degrees. In some embodiments, the angles can be uniformly randomly distributed over such a defined range. In some embodiments, the range of angles can be different for different length line segments that the curves replace. For example, the angles can be biased so that longer arcs have larger angles on average. Curving the line segments in this way has been found to reduce or eliminate the length of straight or nearly straight trace segments that the eye would see in a reflection and thus reduce visible reflections of the resulting electrode. In some embodiments, the traces have a radius of curvature that is distributed between 0.08, or 0.10, or 0.12 times S and 1.5, or 1.7, or 1.9 times S. The distribution of the radius of curvature may be approximately a Gaussian distribution, for example. Curving the traces have been found to improve the uniformity of trace orientation. In some embodiments, the traces of a mesh have a uniform distribution of trace orientation as described in U.S. Pat. No. 8,933,906 (Frey).

The vertex adjustment techniques described above, particularly those involving angles at vertices and cell areas in addition to eliminating short edges, can also be applied after the arcs have been added. The true areas and angles at vertices considering the arcs could then be used in determining desired vertex adjustments.

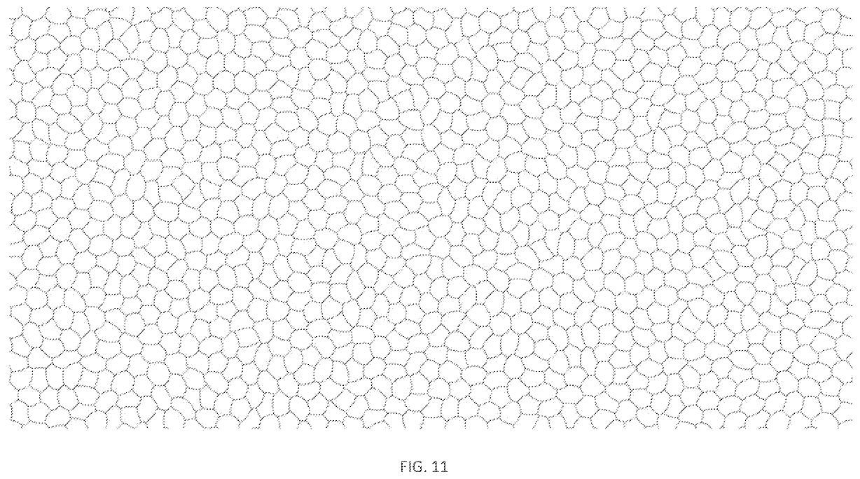

A portion of a mesh tile designed using this Voronoi diagram technique with a core value of 75 percent and maximum arc angles of 20 degrees is shown in FIG. 11. The mesh 402 was designed with this technique using a core value of 75 percent and a maximum arc angle of 30 degrees.

In some embodiments, the tile is configured to be arranged periodically to define a continuously conductive mesh of an electrode, and in some embodiments, the tile is configured to be arranged periodically to define a mesh of an array of electrodes. When the tile defines a mesh of an array of electrodes, regions of the traces to be omitted to form breaks in the traces (see, e.g., FIG. 3D) are identified in the portion of the tile corresponding to a region between adjacent electrodes.

Once the algorithm has completed designing the mesh tile, the design may be stored in a computer readable format and used to make a mask or tool which is then used to construct a mesh electrode as described further elsewhere herein.

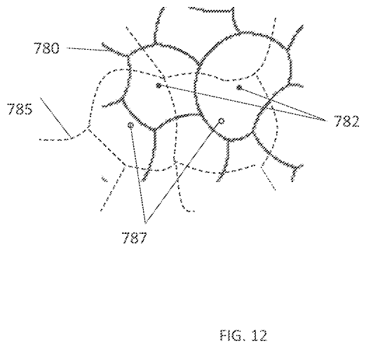

In some embodiments, a method of making a second mesh configured to be overlaid on top of the first mesh is provided. When two independently created meshes are overlaid, there can appear to be some clumping due to closed mesh cell geometry variations (sometimes referred to as clustering). In order to minimize this, the second mesh may be made in the same manner (e.g., using seed points to generate a Voronoi diagram, modifying the vertex positions and curving the traces) as the first mesh, except for the step of generating the seed points. The seed points for the first mesh may be referred to as first seed points and the seed points for the second mesh may be referred to as second seed points. In some embodiments, the second seed points for the second mesh, are selected such that no second seed point is coincident with a first seed point used in generating the first mesh when the second mesh is overlaid on top of the first mesh in a desired orientation of the first and second mesh (e.g., the first mesh corresponding to the first electrodes 600 or an array of the first electrodes 600, and the second mesh corresponding to second electrodes 700 or an array of the second electrodes 700). In some embodiments, the second seed points are selected to be at least 75 percent (or 60 to 80 percent) of S, for example, away from each other, and additionally 45 percent (or 35 to 55 percent) of S, for example, away from the first seed points used in generating the first mesh. FIG. 12 schematically illustrates portions of first and second meshes 780 and 785 overlaid on each other. First mesh 780 may be used in an array of first electrodes and second mesh 785 may be used in an array of second electrodes, for example. No second seed points 787 is coincident with a first seed point 782.

The degree of irregularity of a plurality of vertices that are irregularly arranged can be quantified using various metrics. For example, an arrangement of vertices of a cell can be described by one or more coefficients of variation for one or more corresponding geometric parameters of the arrangement. Furthermore, a composite coefficient of variation can be defined as the sum of two or more such coefficients of variation. To illustrate these concepts, various coefficients of variation will be used to describe various arrangements of vertices. One useful coefficient of variation is the radial coefficient of variation (COVR), another is the perimetral coefficient of variation (COVP). The composite coefficient of variation (COVC), which is the sum of COVR and COVP, is also useful.

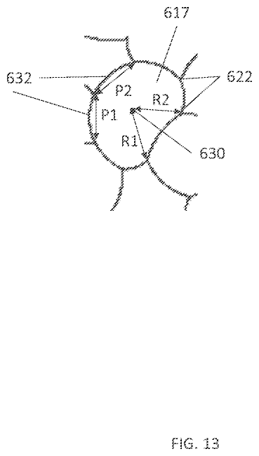

FIG. 13 illustrates various distances used in defining COVR and COVP. FIG. 13 is a top view of closed cell 617 including a plurality of vertices 622 connecting a plurality of electrically conductive traces 632. Each pair of adjacent vertices have a distance (Euclidean distance) between them referred to herein a perimetral distances. Distances P1 and P2 are illustrated in FIG. 13. The number of perimetral distances in a closed cell is equal to the number of vertices of the cell. There are 7 perimetral distances in closed cell 617. The plurality of vertices 622 has a centroid 630. Distances between the vertices and the centroid 630 are referred to herein as radial distances. Radial distances R1 and R2 are illustrated in FIG. 13. The number of radial distances in a closed cell is equal to the number of vertices of the cell. There are 7 radial distances in closed cell 617.

Calculation of COVR can be carried out according to the following steps. First, the centroid of the plurality of vertices is calculated as the arithmetic mean of the position of the vertices in the plurality of vertices. (According to the standard definition in geometry, the centroid of a number of points (e.g., vertices) refers to the point that is calculated as the arithmetic mean of the position of the number of points.) Second, for each vertex, the radial distance Rn between the centroid and that vertex is calculated (or measured). Finally, the coefficient of variation (standard deviation divided by mean) of the radial distances for all of vertices is calculated, giving COVR. According to its standard definition in statistics, a standard deviation of a set of numbers refers to the square root of the average of the squared deviations of the values of the numbers from their average value.

Calculation of COVP can be carried out according to the following steps. First, each perimetral distance Pn between a vertex and its neighboring vertex of a cell (i.e., connected by a trace) is calculated (or measured). Next, the coefficient of variation of all of the perimetral distances is calculated, giving COVP.

Calculation of COVC can be carried out by summing COVR and COVP.

For the vertices of any cell, each of COVR, COVP, and COVC is a number that is greater than or equal to zero. A plurality of vertices that are regularly arranged is characterized by each of COVR, COVP, and COVC being equal to zero. A plurality of vertices that are irregularly arranged is characterized by one or both of COVR and COVP (and consequently COVC) being greater than zero. In some embodiments, COVR is equal to zero and COVP is greater than zero. In some embodiments, COVP is equal to zero and COVR is greater than zero. In some embodiments, both COVR and COVP are greater than zero. The magnitude of irregularly may be described by the magnitudes of COVR, COVP, and COVC.

In some embodiments, the COVR of at least a majority of closed cells (or at least 60 percent, or at least 80 percent, or at least 90 percent, or all of the closed cells) in a mesh is at least 0.02, or at least 0.04, or at least 0.06, or at least 0.08, or at least 0.1, or at least 0.2, or at least 0.3. In some embodiments, the COVR of at least a majority of closed cells (or at least 60 percent, or at least 80 percent, or at least 90 percent, or all of the closed cells) in a mesh is no more than 0.4, or no more than 0.3, or no more than 0.2. In some embodiments, the COVR for each closed cell in a mesh is between 0.02 and 0.3, or between 0.04 and 0.2, or between 0.06 and 0.2.

In some embodiments, the COVP of at least a majority of closed cells (or at least 60 percent, or at least 80 percent, or at least 90 percent, or all of the closed cells) in a mesh is at least 0.02, or at least 0.04, or at least 0.06, or at least 0.08, or at least 0.1, or at least 0.2, or at least 0.3. In some embodiments, the COVP of at least a majority of closed cells (or at least 60 percent, or at least 80 percent, or at least 90 percent, or all of the closed cells) in a mesh is no more than 0.7, or no more than 0.6. In some embodiments, the COVP for each closed cell in a mesh is between 0.02 and 0.6, or between 0.04 and 0.5, or between 0.06 and 0.4.

In some embodiments, the COVC of at least a majority of closed cells (or at least 60 percent, or at least 80 percent, or at least 90 percent, or all of the closed cells) in a mesh is at least 0.02, or at least 0.04, in or at least 0.06, or at least 0.08, or at least 0.1, or at least 0.2, or at least 0.3, or at least 0.4, or at least 0.5. In some embodiments, the COVC of at least a majority of closed cells (or at least 60 percent, or at least 80 percent, or at least 90 percent, or all of the closed cells) in a mesh is no more than 0.8, or no more than 0.7, or no more than 0.6. In some embodiments, the COVC for each closed cell in a mesh is between 0.02 and 0.7, or between 0.05 and 0.6, or between 0.1 and 0.5.

In some cases, it is useful to describe a plurality of cells making up a conductive mesh in terms of the distributions of one or more of the COVR, COVP, and COVC values. For the COVR distribution, percentile values (e.g., tenth percentile, twentieth percentile, fiftieth percentile, eightieth percentile, and ninetieth percentile) can be determined according to their standard definition. For example, a plurality of closed cells having a COVR distribution having ninetieth percentile of 0.2 means that ninety percent of the closed cells have a COVR less than 0.2. Similarly, percentile values can be determined for the COVP distribution or the COVC distribution.

For the purpose of describing the area of a cell of a conductive mesh, at least four different measures may be used. In a first approach, the area of the cell is determined directly with no adjustment to the shape of the traces that connect the vertices of the cell. This first area measure will be referred to as the true cell area. The true area can be determined, for example, by standard methods of geometry, image analysis, and the like. In a second approach for describing the area of a cell, first a polygonal cell is defined as that cell given by connecting the vertices of the cell with straight traces. In embodiments, where the mesh is given by replacing straight line segments of a modified Voronoi diagram with curved lines, the polygonal cells are the cells of the modified Voronoi diagram. Then, in this second approach, the area of the polygonal cell is determined. This area will be referred to as the polygonal cell area. The polygonal cell area may differ from the true cell area when the actual cell is defined by curved traces. The polygonal cell area can be determined, for example, by standard methods of geometry, image analysis, and the like. In a third approach, the true cell area for each cell in the plurality is divided by the average of true cell areas for all of the plurality of cells. The average refers to the unweighted arithmetic mean unless specified differently. This third measure will be referred to as the normalized true cell area. In a fourth approach, the polygonal cell area for each cell in the plurality is divided by the average of polygonal cell areas for all of the plurality of cells. This fourth measure will be referred to as the normalized polygonal cell area.

For a plurality of cells making up a conductive mesh, a distribution of true cell area values, a distribution of polygonal cell areas values, a distribution of normalized true cell area values, and a distribution of normalized polygonal cell areas that each relate to the plurality of cells can be determined. Percentile values (e.g., tenth percentile, twentieth percentile, fiftieth percentile, eightieth percentile, and ninetieth percentile) for any of these distributions can be determined according to their standard definition.

In some embodiments, a conductive mesh includes cells having a COVR distribution characterized by a ninetieth percentile of at least 0.05, or at least 0.1, or at least 0.12, or at least 0.18, or at least 0.2. In some embodiments, the ninetieth percentile is no more than 0.30, or no more than 0.25, or no more than 0.20. In some embodiments, a conductive mesh includes cells having a COVR distribution characterized by a tenth percentile of at least 0.02, or at least 0.03, or at least 0.04, or at least 0.065. In some embodiments, the tenth percentile is no more than 0.1, or no more than 0.09, or no more than 0.085, or no more than 0.07. In some embodiments, a conductive mesh includes cells having a COVR distribution characterized by a tenth percentile from 0.02 to 0.10 and a ninetieth percentile from 0.05 to 0.30, or a tenth percentile from 0.03 to 0.09 and a ninetieth percentile from 0.10 to 0.25, or a tenth percentile from 0.04 to 0.07 and a ninetieth percentile from 0.12 to 0.20.

In some embodiments, a conductive mesh includes cells having a COVP distribution characterized by a ninetieth percentile of at least 0.05, or at least 0.1, or at least 0.18, or at least 0.2, or at least 0.25, or at least 0.3, or at least 0.4, or at least 0.5. In some embodiments, the ninetieth percentile is no more than 1.05, or no more than 0.9, or no more than 0.8, or no more than 0.7, or no more than 0.65, or no more than 0.5. In some embodiments, a conductive mesh includes cells having COVP distribution characterized by a tenth percentile of at least 0.05, or at least 0.1, or at least 0.18 and no more than 0.35, or no more than 0.33, or no more than 0.30. In some embodiments, a conductive mesh includes cells having a COVP distribution characterized by a tenth percentile from 0.05 to 0.35 and a ninetieth percentile from 0.05 to 0.80, or a tenth percentile from 0.07 to 0.25 and a ninetieth percentile from 0.20 to 0.65, or a tenth percentile from 0.10 to 0.20 and a ninetieth percentile from 0.30 to 0.50. In some embodiments, a conductive mesh includes cells having a COVP distribution characterized by a tenth percentile from 0.18 to 0.33 and a ninetieth percentile from 0.40 to 0.80, or a tenth percentile from 0.20 to 0.30 and a ninetieth percentile from 0.50 to 0.70.

In some embodiments, a conductive mesh includes cells having a COVC distribution characterized by a ninetieth percentile of at least 0.1, or at least 0.25, or at least 0.4, or at least 0.5, or at least 0.55. In some embodiments, the ninetieth percentile is no more than 1.05, or no more than 0.9, or no more than 0.7. In some embodiments, a conductive mesh includes cells having a COVC distribution characterized by a tenth percentile of at least 0.05, or at least 0.1, or at least 0.12, or at least 0.15, or at least 0.2, or at least 0.25, or at least 0.3. In some embodiments, the tenth percentile is no more than 0.5, or no more than 0.4, or no more than 0.35, or no more than 0.3. In some embodiments, a conductive mesh includes cells having a COVC distribution characterized by a tenth percentile from 0.10 to 0.50 and a ninetieth percentile from 0.10 to 1.05, or a tenth percentile from 0.12 to 0.40 and a ninetieth percentile from 0.25 to 0.90, or a tenth percentile from 0.15 to 0.30 and a ninetieth percentile from 0.40 to 0.70, or a tenth percentile from 0.25 to 0.50 and a ninetieth percentile from 0.55 to 1.05, or a tenth percentile from 0.30 to 0.40 and a ninetieth percentile from 0.60 to 0.90.

In some embodiments, a conductive mesh includes cells having normalized polygonal cell area distribution characterized by a ninetieth percentile less than 1.50, or less than 1.30, or less than 1.25, or less than 1.2, or less than 1.15, or less than 1.1. In some embodiments, a conductive mesh includes cells having normalized polygonal cell area distribution characterized by a tenth percentile greater than 0.5, or greater than 0.7, or greater than 0.75, or greater than 0.8, or greater than 0.85, or greater than 0.9. In some embodiments, a conductive mesh includes cells having normalized polygonal cell area distribution characterized by a tenth percentile greater than 0.50 and a ninetieth percentile less than 1.50, or a tenth percentile greater than 0.70 and a ninetieth percentile less than 1.30, or a tenth percentile greater than 0.85 and a ninetieth percentile less than 1.15, or a tenth percentile greater than 0.75 and a ninetieth percentile less than 1.25, or a tenth percentile greater than 0.80 and a ninetieth percentile less than 1.20, or tenth percentile greater than 0.85 and a ninetieth percentile less than 1.15, or a tenth percentile greater than 0.90 and a ninetieth percentile less than 1.10.

Table 1 gives properties of the distributions of normalized cell areas and coefficients of variation for a preferred embodiment made starting with the hard-core Voronoi diagram technique with using a core value of 75 percent, modifying the positions of the vertices using iterative techniques described elsewhere herein, and then replacing the line segments with curved lines. Table 2 shows similar properties estimated using Gaussian fits to distributions estimated from the portion of the mesh illustrated in FIG. 5 of U.S. Pat. No. 9,320,136 (Frey et al.). Tables 3-6 show distribution data for the normalized polygonal cell area, COVR, COVP, and COVC, respectively, for mesh designs of Tables 1 and 2 and for various hard-core Voronoi diagrams. It has been found that preferred results are obtained using a core value of at least 45 percent, and more preferably at least 60 percent.

TABLE 1

| | Normalized | Normalized | | | |
|---|---|---|---|---|---|
| | Polygonal | True Cell | | | |
| | Cell Area | Area | COVR | COVP | COVC |
| Minimum | 0.8201 | 0.5871 | 0.0061 | 0.0181 | 0.0293 |
| 10th Percentile | 0.9232 | 0.8521 | 0.0497 | 0.1312 | 0.1900 |
| 20th Percentile | 0.9405 | 0.9027 | 0.0618 | 0.1723 | 0.2434 |
| 50th Percentile | 0.9900 | 1.0007 | 0.0900 | 0.2698 | 0.3661 |
| 80th Percentile | 1.0545 | 1.0970 | 0.1251 | 0.3805 | 0.4994 |
| 90th Percentile | 1.0929 | 1.1463 | 0.1461 | 0.4426 | 0.5704 |
| Maximum | 1.3291 | 1.4454 | 0.2951 | 0.8349 | 0.9618 |
| Average | 1.0000 | 1.0000 | 0.0947 | 0.2802 | 0.3749 |
| Median | 0.9900 | 1.0007 | 0.0900 | 0.2698 | 0.3661 |
| Mode | 0.9453 | 1.0048 | 0.0813 | 0.2398 | 0.3475 |
| Std. Dev. | 0.0673 | 0.1139 | 0.0382 | 0.1202 | 0.1454 |

TABLE 2

| | Normalized | Normalized | | | |
|---|---|---|---|---|---|
| | Polygonal | True Cell | | | |
| | Cell Area | Area | COVR | COVP | COVC |
| Minimum | 0.7152 | 0.6452 | 0.0496 | 0.0975 | 0.1471 |
| 10th Percentile | 0.7261 | 0.6867 | 0.0602 | 0.1660 | 0.2364 |
| 20th Percentile | 0.8201 | 0.7942 | 0.0790 | 0.2024 | 0.2881 |
| 50th Percentile | 1.0000 | 1.0000 | 0.1150 | 0.2719 | 0.3870 |
| 80th Percentile | 1.1799 | 1.2058 | 0.1511 | 0.3415 | 0.4858 |
| 90th Percentile | 1.2739 | 1.3133 | 0.1699 | 0.3779 | 0.5375 |
| Maximum | 1.4157 | 1.3641 | 0.2218 | 0.4397 | 0.6615 |
| Average | 1.0000 | 1.0000 | 0.1150 | 0.2719 | 0.3870 |
| Median | 1.0000 | 1.0000 | 0.1150 | 0.2719 | 0.3870 |
| Mode | n/a | n/a | n/a | n/a | n/a |
| Std. Dev. | 0.2137 | 0.2445 | 0.0428 | 0.0827 | 0.1175 |

TABLE 3
Normalized Polygonal Cell Area

| | Design of | Design of | | | | | | |
|---|---|---|---|---|---|---|---|---|
| | Table 2 | Table 1 | Core = 75% | Core = 60% | Core = 45% | Core = 30% | Core = 15% | Core = 0% |
| Minimum | 0.7152 | 0.8201 | 0.6349 | 0.4554 | 0.2691 | 0.1810 | 0.0968 | 0.0156 |
| 10th Percentile | 0.7261 | 0.9232 | 0.8226 | 0.7293 | 0.6111 | 0.5088 | 0.4378 | 0.4073 |
| 20th Percentile | 0.8201 | 0.9405 | 0.8745 | 0.8040 | 0.7050 | 0.6283 | 0.5677 | 0.5454 |
| 50th Percentile | 1.0000 | 0.9900 | 0.9860 | 0.9698 | 0.9474 | 0.9234 | 0.9158 | 0.9092 |
| 80th Percentile | 1.1799 | 1.0545 | 1.1197 | 1.1809 | 1.2574 | 1.3403 | 1.3808 | 1.3962 |
| 90th Percentile | 1.2739 | 1.0929 | 1.1950 | 1.3086 | 1.4577 | 1.5897 | 1.6788 | 1.6995 |
| Maximum | 1.4157 | 1.3291 | 1.6257 | 2.2574 | 3.3343 | 4.4253 | 4.1667 | 4.4445 |
| Average | 1.0000 | 1.0000 | 1.0000 | 1.0000 | 1.0000 | 1.0000 | 1.0000 | 1.0000 |
| Median | 1.0000 | 0.9900 | 0.9860 | 0.9698 | 0.9474 | 0.9234 | 0.9158 | 0.9093 |
| Mode | 0.0000 | 0.9453 | 0.9428 | 0.8694 | 0.8076 | 0.8119 | 0.8118 | 0.7937 |
| Std. Dev. | 0.2137 | 0.0673 | 0.1440 | 0.2307 | 0.3433 | 0.4357 | 0.5060 | 0.5308 |

TABLE 4
COVR

| | Design of | Design of | | | | | | |
|---|---|---|---|---|---|---|---|---|
| | Table 2 | Table 1 | Core = 75% | Core = 60% | Core = 45% | Core = 30% | Core = 15% | Core = 0% |
| Minimum | 0.0496 | 0.0061 | 0.0086 | 0.0174 | 0.0088 | 0.0071 | 0.0045 | 0.0038 |
| 10th Percentile | 0.0602 | 0.0497 | 0.0647 | 0.0821 | 0.0981 | 0.1094 | 0.1141 | 0.1151 |
| 20th Percentile | 0.0790 | 0.0618 | 0.0807 | 0.1028 | 0.1214 | 0.1348 | 0.1432 | 0.1460 |
| 50th Percentile | 0.1150 | 0.0900 | 0.1168 | 0.1488 | 0.1770 | 0.1973 | 0.2100 | 0.2138 |
| 80th Percentile | 0.1511 | 0.1251 | 0.1615 | 0.2081 | 0.2449 | 0.2728 | 0.2897 | 0.2976 |
| 90th Percentile | 0.1699 | 0.1461 | 0.1875 | 0.2445 | 0.2877 | 0.3188 | 0.3370 | 0.3496 |
| Maximum | 0.2218 | 0.2951 | 0.3693 | 0.4931 | 0.5798 | 0.7130 | 0.7397 | 0.7771 |
| Average | 0.1150 | 0.0947 | 0.1226 | 0.1575 | 0.1862 | 0.2071 | 0.2194 | 0.2248 |
| Median | 0.1150 | 0.0900 | 0.1168 | 0.1488 | 0.1770 | 0.1973 | 0.2100 | 0.2138 |
| Mode | 0.0000 | 0.0813 | 0.1012 | 0.1396 | 0.1708 | 0.1883 | 0.1734 | 0.2024 |
| Std. Dev. | 0.0428 | 0.0382 | 0.0490 | 0.0645 | 0.0753 | 0.0838 | 0.0887 | 0.0927 |

TABLE 5
COVP

| | Design of | Design of | | | | | | |
|---|---|---|---|---|---|---|---|---|
| | Table 2 | Table 1 | Core = 75% | Core = 60% | Core = 45% | Core = 30% | Core = 15% | Core = 0% |
| Minimum | 0.0975 | 0.0181 | 0.0292 | 0.0244 | 0.0087 | 0.0071 | 0.0045 | 0.0175 |
| 10th Percentile | 0.1660 | 0.1312 | 0.2403 | 0.2870 | 0.3258 | 0.3446 | 0.3598 | 0.3567 |
| 20th Percentile | 0.2024 | 0.1723 | 0.3112 | 0.3684 | 0.4111 | 0.4350 | 0.4470 | 0.4512 |
| 50th Percentile | 0.2719 | 0.2698 | 0.4567 | 0.5233 | 0.5678 | 0.5932 | 0.6066 | 0.6168 |
| 80th Percentile | 0.3415 | 0.3805 | 0.5894 | 0.6695 | 0.7163 | 0.7488 | 0.7622 | 0.7750 |
| 90th Percentile | 0.3779 | 0.4426 | 0.6600 | 0.7445 | 0.7943 | 0.8277 | 0.8447 | 0.8572 |
| Maximum | 0.4397 | 0.8349 | 1.0427 | 1.1575 | 1.1999 | 1.2912 | 1.3504 | 1.4802 |
| Average | 0.2719 | 0.2802 | 0.4542 | 0.5206 | 0.5650 | 0.5909 | 0.6038 | 0.6134 |
| Median | 0.2719 | 0.2698 | 0.4568 | 0.5233 | 0.5678 | 0.5932 | 0.6066 | 0.6168 |
| Mode | 0.0000 | 0.2398 | 0.5085 | 0.5603 | 0.5721 | 0.5797 | 0.6411 | 0.6302 |
| Std. Dev. | 0.0827 | 0.1202 | 0.1588 | 0.1745 | 0.1796 | 0.1857 | 0.1889 | 0.1937 |

TABLE 6
COVC

| | Design of | Design of | | | | | | |
|---|---|---|---|---|---|---|---|---|
| | Table 2 | Table 1 | Core = 75% | Core = 60% | Core = 45% | Core = 30% | Core = 15% | Core = 0% |
| Minimum | 0.1471 | 0.0293 | 0.0685 | 0.0564 | 0.0175 | 0.0141 | 0.0090 | 0.0348 |
| 10th Percentile | 0.2364 | 0.1900 | 0.3494 | 0.4236 | 0.4879 | 0.5231 | 0.5443 | 0.5509 |
| 20th Percentile | 0.2881 | 0.2434 | 0.4283 | 0.5139 | 0.5793 | 0.6215 | 0.6450 | 0.6510 |
| 50th Percentile | 0.3870 | 0.3661 | 0.5826 | 0.6809 | 0.7522 | 0.7979 | 0.8215 | 0.8384 |
| 80th Percentile | 0.4858 | 0.4994 | 0.7219 | 0.8381 | 0.9199 | 0.9739 | 1.0008 | 1.0252 |
| 90th Percentile | 0.5375 | 0.5704 | 0.7909 | 0.9217 | 1.0091 | 1.0694 | 1.0999 | 1.1278 |
| Maximum | 0.6615 | 0.9618 | 1.1126 | 1.4383 | 1.5217 | 1.7514 | 1.7362 | 1.7358 |
| Average | 0.3870 | 0.3749 | 0.5768 | 0.6781 | 0.7513 | 0.7980 | 0.8232 | 0.8382 |
| Median | 0.3870 | 0.3661 | 0.5826 | 0.6809 | 0.7522 | 0.7979 | 0.8215 | 0.8385 |
| Mode | 0.0000 | 0.3475 | 0.6188 | 0.7100 | 0.7696 | 0.7889 | 0.8259 | 0.7934 |
| Std. Dev. | 0.1175 | 0.1454 | 0.1686 | 0.1919 | 0.2031 | 0.2139 | 0.2184 | 0.2265 |

After a mesh design has been provided using the methods described elsewhere herein, conductive meshes, electrodes and arrays of electrodes according to the present description can be prepared using any suitable method. Examples of methods for preparing meshes include subtractive or additive methods. Exemplary subtractive methods include placement of a patterned mask on a metallic coating disposed on a substrate (e.g., a visible light transparent substrate), followed by selective etching (with metal being removed from regions of the metallic coating that are not covered by the mask, and with metal remaining in regions of the metallic coating that are covered by the mask). Suitable masks include photoresist (patterned by photolithography, as is known in the art), printed polymers, or printed self-assembled monolayers (for example, printed using microcontact printing). Other exemplary subtractive methods include initial placement of a patterned lift-off mask on a substrate (e.g., a visible light transparent substrate), blanket coating of masked and unmasked regions with a metallic conductor (e.g., thin film metal), and washing of the lift-off mask and any metal disposed thereon. Exemplary additive processes include printing of electroless deposition catalyst on a substrate (e.g., visible light transparent substrate) in the form of the desired mesh geometry, followed by patterned electroless metal deposition (e.g., copper or nickel).

Preferred methods for generating the conductive meshes include microcontact printing or a combination of microcontact printing and etching. Such methods have been found to be useful in fabricating meshes with desired mesh parameters which may include trace width (e.g., from 0.5 to 10 micrometers, from 0.5 to 5 micrometers, or from 1 to 3 micrometers) and trace thickness (e.g., from 0.001 to 2 micrometers, from 0.05 to 1 micrometers, 0.075 to 0.5 micrometers, or from 0.1 to 0.25 micrometers).

Other methods for generating the conductive meshes include the application of conductive inks or precursors to a substrate surface, for example by printing (e.g., flexographic printing, gravure printing, electrostatic printing, or inkjet printing). Suitable methods also include processes whereby conductive inks or precursors are deposited into pre-formed trenches of a substrate surface, for example, as described in U.S. Pat. No. 6,951,666 (Kodas et al.).

In some embodiments, the electrodes are configured to have a low reflectance in order to reduce their visibility or in order to reduce undesirable visual effects. In some embodiments, the traces are disposed a first surface of a substrate where the first surface is a nanostructured surface that is antireflective when exposed to air and where the traces have specular reflectance in a direction orthogonal to and toward the first surface of the substrate of less than 50 percent. Articles including such substrates with a mesh pattern of conductive traces are described in U.S. Pat. Pub. No. 2013/0299214 (Frey et al.). In some embodiments, the traces are a formed from a multilayer material including, in sequence, a semi-reflective metal, a transparent layer and a reflective layer. Such traces are described in U.S. Pat. No. 9,320,136 (Frey et al.).

In the case of a substrate having a nanostructured surface that is antireflective when exposed to air, a conductive mesh can be made as follows: a substrate (e.g., a visible light transparent substrate) is provided that includes a surface that is nanostructured and that is antireflective when exposed to air; a metallic conductor is deposited (e.g., by sputtering or by evaporation) onto the surface; a self-assembled monolayer (SAM) is printed in a pattern using an elastomeric stamp; and finally the metal is etched from deposited metal regions not having the SAM and not etched from deposited metal regions that include the SAM.

In the case of a multi-layer material conductor, a conductive mesh can be made as follows: a substrate (e.g., a visible light transparent substrate) is provided, with a major surface; a semi-reflective metal is deposited on the substrate surface (in some cases titanium with thickness between 1 and 20 nanometers); a transparent material is deposited on the semi-reflective metal (in some cases SiO₂ with thickness between 50 and 100 nanometers); an opaque reflective metal is deposited on the transparent material (in some cases Ti metallic conductor is deposited first as an adhesion promoting layer with a thickness of from 5 angstroms to 5 nanometers, followed by silver with a thickness of from 50 nanometers to 250 nanometers); a self-assembled monolayer (SAM) is printed in a pattern using an elastomeric stamp; and finally the silver is etched from deposited metal regions not having the SAM and not etched from deposited metal regions that include the SAM; in a second stage of etching, the subsequent layers of material under the opaque, reflective metal are etched from deposited metal regions not having the SAM and not etched from deposited metal regions that include the SAM.

Suitable metals for use in a single layer trace, for example, or for use as an opaque, highly reflective layer in a multilayer trace include silver, palladium, platinum, aluminum, copper, molybdenum, nickel, tin, tungsten, alloys, and combinations thereof. Suitable metals for the semi-reflective metal layer in a multilayer trace include titanium, chromium, aluminum, nickel, copper, gold, molybdenum, platinum, rhodium, silver, tungsten, cobalt, iron, germanium, hafnium, palladium, rhenium, vanadium, silicon, selenium, tantalum, yttrium, zirconium and combinations and alloys thereof. Suitable materials for the transparent material in a multilayer trace include acrylic polymers, SiO₂, Al₂O₃, ZrO₂, TiO₂, HfO₂, Sc₂O₃, La₂O₃, ThO₂, Y₂O₃, CeO₂, MgO, Ta₂O₅ and combinations thereof. In some embodiments, the semi-reflective metal comprises chromium or titanium, the opaque and reflective metal comprises silver or aluminum, and the transparent material comprises acrylic polymer, SiO₂, or TiO₂.

The following is a list of exemplary embodiments of the present description.

Embodiment 1 is a continuously electrically conductive electrode comprising:
an electrically conductive first mesh repeating across the electrode to form a two-dimensional regular array of the first mesh, the first mesh comprising a plurality of conductive closed cells, each closed cell comprising a plurality of vertices connecting a plurality of electrically conductive traces; and
an electrically conductive second mesh different from the first mesh and comprising a plurality of conductive closed cells, each closed cell comprising a plurality of vertices connecting a plurality of electrically conductive traces, wherein the vertices in the plurality of vertices in each closed cell for at least one of the first and second meshes are irregularly arranged.

Embodiment 2 is the continuously electrically conductive electrode of Embodiment 1, wherein the vertices in the plurality of vertices in each cell for each of the first and second meshes are irregularly arranged.

Embodiment 3 is the continuously electrically conductive electrode of Embodiment 1, wherein at least one of the first and second meshes comprises at least one open cell.

Embodiment 4 is the continuously electrically conductive electrode of Embodiment 1, wherein each trace in the plurality of electrically conductive traces of the first mesh is curved.

Embodiment 5 is the continuously electrically conductive electrode of Embodiment 1, wherein each of a majority of traces in the plurality of electrically conductive traces of the first mesh is curved.

Embodiment 6 is the continuously electrically conductive electrode of Embodiment 1, further comprising an electrically conductive third mesh different from the first and second meshes and comprising a plurality of conductive closed cells, each closed cell in the third mesh comprising a plurality of vertices connecting a plurality of electrically conductive traces.

Embodiment 7 is the continuously electrically conductive electrode of Embodiment 6, wherein the vertices in the plurality of vertices in each cell for each of the first, second and third meshes are irregularly arranged.

Embodiment 8 is the continuously electrically conductive electrode of any one of Embodiments 1 to 7, wherein each trace in each of the pluralities of electrically conductive traces is curved.

Embodiment 9 is the continuously electrically conductive electrode of Embodiment 1, wherein the first mesh comprises a plurality of open cells at a perimeter of the first mesh such that for at least one first open cell in the plurality of open cells there is a different second open cell in the plurality of open cells that when translated linearly along at least one direction, combines with the first open cell to form a combined closed cell.

Embodiment 10 is the continuously electrically conductive electrode of Embodiment 1, wherein each of a majority of the closed cells of the first mesh has a radial coefficient of variation of at least 0.02, the radial coefficient of variation being a standard deviation of radial distances to the plurality of vertices of a closed cell from a centroid of the plurality of vertices of the closed cell divided by a mean of the radial distances.

Embodiment 11 is the continuously electrically conductive electrode of Embodiment 10, wherein each of a majority of the closed cells of the first mesh has a radial coefficient of variation of at least 0.04.

Embodiment 12 is the continuously electrically conductive electrode of Embodiment 10, wherein each of a majority of the closed cells of the first mesh has a radial coefficient of variation of at least 0.08.

Embodiment 13 is the continuously electrically conductive electrode of Embodiment 10, wherein each of a majority of the closed cells of the first mesh has a radial coefficient of variation of at least 0.2.

Embodiment 14 is the continuously electrically conductive electrode of any one of Embodiments 1 to 13, wherein each of a majority of the closed cells of the first mesh has a radial coefficient of variation of no more than 0.3.

Embodiment 15 is the continuously electrically conductive electrode of Embodiment 14, wherein each of a majority of the closed cells of the first mesh has a radial coefficient of variation of no more than 0.2.

Embodiment 16 is the continuously electrically conductive electrode of any one of Embodiments 1 to 15, wherein each of a majority of the closed cells of the first mesh has a perimetral coefficient of variation of at least 0.02, the perimetral coefficient of variation being a standard deviation of distances between adjacent vertices in a plurality of vertices of a closed cell divided by a mean of the distances.

Embodiment 17 is the continuously electrically conductive electrode of Embodiment 16, wherein each of a majority of the closed cells of the first mesh has a perimetral coefficient of variation of at least 0.04.

Embodiment 18 is the continuously electrically conductive electrode of Embodiment 16, wherein each of a majority of the closed cells of the first mesh has a perimetral coefficient of variation of at least 0.08.

Embodiment 19 is the continuously electrically conductive electrode of Embodiment 16, wherein each of a majority of the closed cells of the first mesh has a perimetral coefficient of variation of at least 0.2.

Embodiment 20 is the continuously electrically conductive electrode of any one of Embodiments 1 to 19, wherein each of a majority of the closed cells of the first mesh has a perimetral coefficient of variation of no more than 0.6.

Embodiment 21 is the continuously electrically conductive electrode of Embodiment 1, wherein each of a majority of the closed cells of the first mesh has a composite coefficient of variation of at least 0.02, the composite coefficient of variation being a sum of a radial coefficient of variation and a perimetral coefficient of variation, the radial coefficient of variation being a standard deviation of radial distances to the plurality of vertices of the closed cell from a centroid of the plurality of vertices of the closed cell divided by a mean of the radial distances, the perimetral coefficient of variation being a standard deviation of distances between adjacent vertices in the plurality of vertices of the closed cell divided by a mean of the distances between adjacent vertices.

Embodiment 22 is the continuously electrically conductive electrode of Embodiment 21, wherein each of a majority of the closed cells of the first mesh has a composite coefficient of variation of at least 0.04.

Embodiment 23 is the continuously electrically conductive electrode of Embodiment 21, wherein each of a majority of the closed cells of the first mesh has a composite coefficient of variation of at least 0.08.

Embodiment 24 is the continuously electrically conductive electrode of Embodiment 21, wherein each of a majority of the closed cells of the first mesh has a composite coefficient of variation of at least 0.2.

Embodiment 25 is the continuously electrically conductive electrode of any one of Embodiments 1 to 24, wherein each of a majority of the closed cells of the first mesh has a composite coefficient of variation of no more than 0.8.

Embodiment 26 is the continuously electrically conductive electrode of any one of Embodiments 1 to 24, wherein each of a majority of the closed cells of the first mesh has a composite coefficient of variation of no more than 0.6.

Embodiment 27 is the continuously electrically conductive electrode of Embodiment 1, wherein the closed cells of the first mesh have a distribution of radial coefficient of variation having a ninetieth percentile in a range of 0.05 to 0.30, the radial coefficient of variation being a standard deviation of radial distances to a plurality of vertices of a closed cell from a centroid of the plurality of vertices of the closed cell divided by a mean of the radial distances.

Embodiment 28 is the continuously electrically conductive electrode of Embodiment 27, wherein the ninetieth percentile is at least 0.1.

Embodiment 29 is the continuously electrically conductive electrode of Embodiment 27, wherein the ninetieth percentile is at least 0.18.

Embodiment 30 is the continuously electrically conductive electrode of any one of Embodiments 27 to 29, wherein the ninetieth percentile is no more than 0.25.

Embodiment 31 is the continuously electrically conductive electrode of any one of Embodiments 27 to 30, wherein the closed cells of the first mesh have a distribution of radial coefficient of variation having a tenth percentile in a range of 0.02 to 0.1.

Embodiment 32 is the continuously electrically conductive electrode of Embodiment 31, wherein the tenth percentile is in a range of 0.03 to 0.09.

Embodiment 33 is the continuously electrically conductive electrode of Embodiment 32, wherein the tenth percentile is in a range of 0.04 to 0.085.

Embodiment 34 is the continuously electrically conductive electrode of Embodiment 1, wherein the closed cells of the first mesh have a distribution of perimetral coefficient of variation having a ninetieth percentile in a range of 0.05 to 0.80, the perimetral coefficient of variation being a standard deviation of distances between adjacent vertices in a plurality of vertices of a closed cell divided by a mean of the distances between adjacent vertices.

Embodiment 35 is the continuously electrically conductive electrode of Embodiment 34, wherein the ninetieth percentile is at least 0.2.

Embodiment 36 is the continuously electrically conductive electrode of Embodiment 34, wherein the ninetieth percentile is at least 0.4.

Embodiment 37 is the continuously electrically conductive electrode of Embodiment 34, wherein the ninetieth percentile is at least 0.5.

Embodiment 38 is the continuously electrically conductive electrode of any one of Embodiments 34 to 37, wherein the ninetieth percentile is no more than 0.7.

Embodiment 39 is the continuously electrically conductive electrode of any one of Embodiments 34 to 37, wherein the distribution of perimetral coefficient of variation has a tenth percentile in a range of 0.05 to 0.35.

Embodiment 40 is the continuously electrically conductive electrode of Embodiment 39, wherein the tenth percentile is at least 0.1.

Embodiment 41 is the continuously electrically conductive electrode of Embodiment 39, wherein the tenth percentile is at least 0.18.

Embodiment 42 is the continuously electrically conductive electrode of Embodiment 39, wherein the tenth percentile is no more than 0.33.

Embodiment 43 is the continuously electrically conductive electrode of Embodiment 39, wherein the tenth percentile is no more than 0.30.

Embodiment 44 is the continuously electrically conductive electrode of Embodiment 1, wherein the closed cells of the first mesh have a distribution of composite coefficient of variation having a ninetieth percentile in a range of 0.1 to 1.05, the composite coefficient of variation being a sum of a radial coefficient of variation and a perimetral coefficient of variation, the radial coefficient of variation being a standard deviation of radial distances to a plurality of vertices of a closed cell from a centroid of the plurality of vertices of the closed cell divided by a mean of the radial distances, the perimetral coefficient of variation being a standard deviation of distances between adjacent vertices in the plurality of vertices of the closed cell divided by a mean of the distances between adjacent vertices.

Embodiment 45 is the continuously electrically conductive electrode of Embodiment 44, wherein the ninetieth percentile is at least 0.25.

Embodiment 46 is the continuously electrically conductive electrode of Embodiment 44, wherein the ninetieth percentile is at least 0.55.

Embodiment 47 is the continuously electrically conductive electrode of any one of Embodiments 44 to 46, wherein the ninetieth percentile is no more than 0.9.

Embodiment 48 is the continuously electrically conductive electrode of any one of Embodiments 44 to 47, wherein the closed cells of the first mesh have a distribution of composite coefficient of variation having a tenth percentile in a range of 0.05 to 0.5.

Embodiment 49 is the continuously electrically conductive electrode of Embodiment 48, wherein the tenth percentile is at least 0.1.

Embodiment 50 is the continuously electrically conductive electrode of Embodiment 48, wherein the tenth percentile is no more than 0.35.

Embodiment 51 is the continuously electrically conductive electrode of Embodiment 1, wherein the closed cells of the first mesh have a normalized polygonal cell area distribution characterized by a ninetieth percentile less than 1.50.

Embodiment 52 is the continuously electrically conductive electrode of Embodiment 51, wherein the ninetieth percentile is less than 1.3.

Embodiment 53 is the continuously electrically conductive electrode of any one of Embodiments 51 to 52, wherein the normalized polygonal cell area distribution has a tenth percentile greater than 0.5.

Embodiment 54 is the continuously electrically conductive electrode of Embodiment 53, wherein the tenth percentile is greater than 0.7.

Embodiment 55 is a continuously electrically conductive tiled electrode comprising a first plurality of tiles arranged along a first direction and comprising a first plurality of pairs of adjacent tiles, such that each pair of adjacent tiles in the first plurality of pairs of adjacent tiles comprises a common border and a same plurality of irregularly arranged electrically conductive traces, each conductive trace extending across the common border at a crossover point and having a continuous first derivative at the crossover point.

Embodiment 56 is the continuously electrically conductive tiled electrode of Embodiment 55, wherein each tile in the first plurality of tiles comprises a plurality of conductive open cells along the common border with an adjacent tile.

Embodiment 57 is the continuously electrically conductive tiled electrode of Embodiment 56, wherein at least one open cell in each tile in the first plurality of tiles combine with an open cell of an adjacent tile at the common border to form a combined closed cell.

Embodiment 58 is the continuously electrically conductive tiled electrode of Embodiment 55, wherein each tile in the first plurality of tiles comprises a plurality of open cells along a perimeter of the tile, such that for each first open cell at the perimeter, there is a different second open cell at the perimeter that when translated linearly along the first direction, combines with the first open cell to form a combined closed cell comprising a plurality of irregularly arranged vertices.

Embodiment 59 is the continuously electrically conductive tiled electrode of Embodiment 55, further comprising a second plurality of tiles arranged along a second direction different from the first direction and comprising a second plurality of pairs of adjacent tiles, such that each pair of adjacent tiles in the second plurality of pairs of adjacent tiles comprises a common border and a same plurality of irregularly arranged electrically conductive traces, each conductive trace extending across the common border at a crossover point and having a continuous first derivative at the crossover point.

Embodiment 60 is the continuously electrically conductive tiled electrode of Embodiment 59, wherein each tile in the second plurality of tiles comprises a plurality of open cells along a perimeter of the tile, such that for each third open cell at the perimeter, there is a different fourth open cell at the perimeter that when translated linearly along the second direction, combines with the third open cell to form a combined closed cell comprising a plurality of irregularly arranged vertices.

Embodiment 61 is the continuously electrically conductive tiled electrode of Embodiment 59, wherein the first and second pluralities of tiles are arranged on a rectangular grid.

Embodiment 62 is the continuously electrically conductive tiled electrode of Embodiment 59, further comprising a third plurality of tiles arranged along a third direction different from the first and second directions and comprising a third plurality of pairs of adjacent tiles, such that each pair of adjacent tiles in the third plurality of adjacent tiles comprises a common border and a same plurality of irregularly arranged electrically conductive traces, each conductive trace extending across the common border at a crossover point and having a continuous first derivative at the crossover point.

Embodiment 63 is the continuously electrically conductive tiled electrode of Embodiment 62, wherein the first, second and third pluralities of tiles are arranged on a hexagonal grid.

Embodiment 64 is the continuously electrically conductive tiled electrode of Embodiment 55, wherein each tile in the first plurality of tiles comprises a plurality of conductive closed cells, each closed cell comprising a plurality of vertices connecting a plurality of electrically conductive traces.

Embodiment 65 is the continuously electrically conductive tiled electrode of Embodiment 64, wherein the vertices in the plurality of vertices in each of a majority of the closed cells are irregularly arranged.

Embodiment 66 is the continuously electrically conductive tiled electrode of Embodiment 64, wherein the vertices in the plurality of vertices in each of the closed cells are irregularly arranged.

Embodiment 67 is the continuously electrically conductive tiled electrode of Embodiment 64, wherein each trace in the plurality of electrically conductive traces in each of a majority of the closed cells is curved.

Embodiment 68 is the continuously electrically conductive tiled electrode of Embodiment 64, wherein each trace in the plurality of electrically conductive traces in each of the closed cells is curved.

Embodiment 69 is the continuously electrically conductive tiled electrode of Embodiment 64, wherein each of a majority of the closed cells has a radial coefficient of variation in a range of 0.02 to 0.3, the radial coefficient of variation being a standard deviation of radial distances to a plurality of vertices of a closed cell from a centroid of the plurality of vertices of the closed cell divided by a mean of the radial distances.

Embodiment 70 is the continuously electrically conductive tiled electrode of any one of Embodiments 64 to 69, wherein each of a majority of the closed cells has a perimetral coefficient of variation in a range of 0.02 to 0.6, the perimetral coefficient of variation being a standard deviation of distances between adjacent vertices in a plurality of vertices of a closed cell divided by a mean of the distances.

Embodiment 71 is the continuously electrically conductive tiled electrode of Embodiment 64, wherein each of a majority of the closed cells has a composite coefficient of variation in a range of 0.02 to 0.8, the composite coefficient of variation being a sum of a radial coefficient of variation and a perimetral coefficient of variation, the radial coefficient of variation being a standard deviation of radial distances to the plurality of vertices of the closed cell from a centroid of the plurality of vertices of the closed cell divided by a mean of the radial distances, the perimetral coefficient of variation being a standard deviation of distances between adjacent vertices in the plurality of vertices of the closed cell divided by a mean of the distances between adjacent vertices.

Embodiment 72 is the continuously electrically conductive electrode tiled of Embodiment 64, wherein the closed cells have a distribution of radial coefficient of variation having a ninetieth percentile in a range of 0.05 to 0.30, the radial coefficient of variation being a standard deviation of radial distances to a plurality of vertices of a closed cell from a centroid of the plurality of vertices of the closed cell divided by a mean of the radial distances.

Embodiment 73 is the continuously electrically conductive tiled electrode of Embodiment 64, wherein the closed cells have a distribution of perimetral coefficient of variation having a ninetieth percentile in a range of 0.05 to 0.80, the perimetral coefficient of variation being a standard deviation of distances between adjacent vertices in a plurality of vertices of a closed cell divided by a mean of the distances between adjacent vertices.

Embodiment 74 is the continuously electrically conductive tiled electrode of Embodiment 73, wherein the distribution of perimetral coefficient of variation has a tenth percentile in a range of 0.05 to 0.35.

Embodiment 75 is the continuously electrically conductive tiled electrode of Embodiment 64, wherein the closed cells have a distribution of composite coefficient of variation having a ninetieth percentile in a range of 0.1 to 1.05, the composite coefficient of variation being a sum of a radial coefficient of variation and a perimetral coefficient of variation, the radial coefficient of variation being a standard deviation of radial distances to a plurality of vertices of a closed cell from a centroid of the plurality of vertices of the closed cell divided by a mean of the radial distances, the perimetral coefficient of variation being a standard deviation of distances between adjacent vertices in the plurality of vertices of the closed cell divided by a mean of the distances between adjacent vertices.

Embodiment 76 is the continuously electrically conductive tiled electrode of Embodiment 75, wherein the closed cells have a distribution of composite coefficient of variation having a tenth percentile in a range of 0.05 to 0.5.

Embodiment 77 is the continuously electrically conductive tiled electrode of Embodiment 64, wherein the closed cells have a normalized polygonal cell area distribution characterized by a ninetieth percentile less than 1.50.

Embodiment 78 is the continuously electrically conductive tiled electrode of Embodiment 77, wherein the normalized polygonal cell area distribution has a tenth percentile greater than 0.5.

Embodiment 79 is a continuously electrically conductive electrode comprising an electrically conductive first mesh repeating across the electrode to form a two-dimensional regular array of the first mesh, the first mesh comprising a plurality of conductive closed cells, each of a majority of the closed cells in the plurality of closed cells comprising a plurality of irregularly arranged vertices connecting a plurality of electrically conductive curved traces.

Embodiment 80 is the continuously electrically conductive electrode of Embodiment 79, wherein each closed cell in the plurality of closed cells comprises a plurality of irregularly arranged vertices connecting a plurality of electrically conductive curved traces.

Embodiment 81 is the continuously electrically conductive electrode of Embodiment 79, wherein the closed cells in the plurality of conductive closed cells in the first mesh are irregularly arranged.

Embodiment 82 is the continuously electrically conductive electrode of Embodiment 79, wherein each curved trace of each closed cell comprises a continuous first derivative along an entire length of the curved trace.

Embodiment 83 is the continuously electrically conductive electrode of Embodiment 79, wherein the two-dimensional regular array is a rectangular array.

Embodiment 84 is the continuously electrically conductive electrode of Embodiment 83, wherein the rectangular array is a square array.

Embodiment 85 is the continuously electrically conductive electrode of Embodiment 79, wherein the two-dimensional regular array is a hexagonal array.

Embodiment 86 is the continuously electrically conductive electrode of Embodiment 79, wherein the first mesh comprises at least one open cell.

Embodiment 87 is the continuously electrically conductive electrode of Embodiment 79, further comprising an electrically conductive second mesh different from the first mesh, the second mesh electrically connecting the array of the first mesh.

Embodiment 88 is the continuously electrically conductive electrode of Embodiment 79, wherein the array of the first mesh is directly electrically interconnected.

Embodiment 89 is the continuously electrically conductive electrode of Embodiment 79, wherein each first mesh in the array of the first mesh shares a common border with an adjacent first mesh in the array of the first mesh such that at least one open cell in the first mesh combines with an open cell in the adjacent first mesh along the common border to form a combine closed cell.

Embodiment 90 is the continuously electrically conductive electrode of Embodiment 79, wherein the first mesh comprises a plurality of open cells at a perimeter of the first mesh such that for at least one first open cell in the plurality of open cells there is a different second open cell in the plurality of open cells that when translated linearly along a first direction, combines with the first open cell to form a combined closed cell.

Embodiment 91 is the continuously electrically conductive electrode of Embodiment 79, wherein each of a majority of the closed cells of the first mesh has a radial coefficient of variation in a range of 0.02 to 0.3, the radial coefficient of variation being a standard deviation of radial distances to a plurality of vertices of a closed cell from a centroid of the plurality of vertices of the closed cell divided by a mean of the radial distances.

Embodiment 92 is the continuously electrically conductive electrode of any one of Embodiments 79 to 91, wherein each of a majority of the closed cells of the first mesh has a perimetral coefficient of variation in a range of 0.02 to 0.6, the perimetral coefficient of variation being a standard deviation of distances between adjacent vertices in a plurality of vertices of a closed cell divided by a mean of the distances.

Embodiment 93 is the continuously electrically conductive electrode of any one of Embodiments 79 to 92, wherein each of a majority of the closed cells of the first mesh has a composite coefficient of variation in a range of 0.02 to 0.8, the composite coefficient of variation being a sum of a radial coefficient of variation and a perimetral coefficient of variation, the radial coefficient of variation being a standard deviation of radial distances to the plurality of vertices of the closed cell from a centroid of the plurality of vertices of the closed cell divided by a mean of the radial distances, the perimetral coefficient of variation being a standard deviation of distances between adjacent vertices in the plurality of vertices of the closed cell divided by a mean of the distances between adjacent vertices.

Embodiment 94 is the continuously electrically conductive electrode of Embodiment 79, wherein the closed cells of the first mesh have a distribution of radial coefficient of variation having a ninetieth percentile in a range of 0.05 to 0.30, the radial coefficient of variation being a standard deviation of radial distances to a plurality of vertices of a closed cell from a centroid of the plurality of vertices of the closed cell divided by a mean of the radial distances.

Embodiment 95 is the continuously electrically conductive electrode of Embodiment 79, wherein the closed cells of the first mesh have a distribution of perimetral coefficient of variation having a ninetieth percentile in a range of 0.05 to 0.80, the perimetral coefficient of variation being a standard deviation of distances between adjacent vertices in a plurality of vertices of a closed cell divided by a mean of the distances between adjacent vertices.

Embodiment 96 is the continuously electrically conductive electrode of Embodiment 95, wherein the distribution of perimetral coefficient of variation has a tenth percentile in a range of 0.05 to 0.35.

Embodiment 97 is the continuously electrically conductive electrode of Embodiment 79, wherein the closed cells of the first mesh have a distribution of composite coefficient of variation having a ninetieth percentile in a range of 0.1 to 1.05, the composite coefficient of variation being a sum of a radial coefficient of variation and a perimetral coefficient of variation, the radial coefficient of variation being a standard deviation of radial distances to a plurality of vertices of a closed cell from a centroid of the plurality of vertices of the closed cell divided by a mean of the radial distances, the perimetral coefficient of variation being a standard deviation of distances between adjacent vertices in the plurality of vertices of the closed cell divided by a mean of the distances between adjacent vertices.

Embodiment 98 is the continuously electrically conductive electrode of Embodiment 97, wherein the closed cells of the first mesh have a distribution of composite coefficient of variation having a tenth percentile in a range of 0.05 to 0.5.

Embodiment 99 is the continuously electrically conductive electrode of Embodiment 79, wherein the closed cells of the first mesh have a normalized polygonal cell area distribution characterized by a ninetieth percentile less than 1.50.

Embodiment 100 is the continuously electrically conductive electrode of Embodiment 99, wherein the normalized polygonal cell area distribution has a tenth percentile greater than 0.5.

Embodiment 101 is a continuously electrically conductive mesh comprising a plurality of vertices connecting a plurality of electrically conductive traces, such that the mesh can be divided into a plurality of same size and shape grid cells forming a continuous two-dimensional grid, wherein a perimeter of each grid cell intersects a plurality of irregularly arranged electrically conductive traces in the plurality of electrically conductive traces without passing through a vertex in the plurality of vertices.

Embodiment 102 is the continuously electrically conductive mesh of Embodiment 101, wherein each of a majority of the electrically conductive traces is curved.

Embodiment 103 is the continuously electrically conductive mesh of Embodiment 101, wherein each of the electrically conductive traces is curved.

Embodiment 104 is the continuously electrically conductive mesh of Embodiment 101, wherein the same size and shape grid cells are rectangular.

Embodiment 105 is the continuously electrically conductive mesh of Embodiment 104, wherein the same size and shape grid cells are square.

Embodiment 106 is the continuously electrically conductive mesh of Embodiment 101, wherein the same size and shape grid cells are hexagonal.

Embodiment 107 is the continuously electrically conductive mesh of Embodiment 101, wherein each grid cell comprises a same first mesh.

Embodiment 108 is the continuously electrically conductive mesh of Embodiment 107, wherein the first mesh comprises a plurality of open cells at a perimeter of the first mesh such that for at least one first open cell in the plurality of open cells there is a different second open cell in the plurality of open cells that when translated linearly along a first direction, combines with the first open cell to form a combined closed cell.

Embodiment 109 is the continuously electrically conductive mesh of Embodiment 101, wherein each trace in the plurality of electrically conductive traces has a continuous first derivative along an entire length of the trace.

Embodiment 110 is the continuously electrically conductive mesh of Embodiment 101, wherein each grid cell comprises a same plurality of electrically conductive closed cells, each closed cell comprising a plurality of irregularly arranged vertices connecting a plurality of electrically conductive traces.

Embodiment 111 is the continuously electrically conductive mesh of Embodiment 110, wherein each of a majority of the closed cells has a radial coefficient of variation in a range of 0.02 to 0.3, the radial coefficient of variation being a standard deviation of radial distances to a plurality of vertices of a closed cell from a centroid of the plurality of vertices of the closed cell divided by a mean of the radial distances.

Embodiment 112 is the continuously electrically conductive mesh of any one of Embodiments 110 to 111, wherein each of a majority of the closed cells has a perimetral coefficient of variation in a range of 0.02 to 0.6, the perimetral coefficient of variation being a standard deviation of distances between adjacent vertices in a plurality of vertices of a closed cell divided by a mean of the distances.

Embodiment 113 is the continuously electrically conductive mesh of Embodiment 110, wherein each of a majority of the closed cells has a composite coefficient of variation in a range of 0.02 to 0.8, the composite coefficient of variation being a sum of a radial coefficient of variation and a perimetral coefficient of variation, the radial coefficient of variation being a standard deviation of radial distances to the plurality of vertices of the closed cell from a centroid of the plurality of vertices of the closed cell divided by a mean of the radial distances, the perimetral coefficient of variation being a standard deviation of distances between adjacent vertices in the plurality of vertices of the closed cell divided by a mean of the distances between adjacent vertices.

Embodiment 114 is the continuously electrically conductive mesh of Embodiment 110, wherein the closed cells have a distribution of radial coefficient of variation having a ninetieth percentile in a range of 0.05 to 0.30, the radial coefficient of variation being a standard deviation of radial distances to a plurality of vertices of a closed cell from a centroid of the plurality of vertices of the closed cell divided by a mean of the radial distances.

Embodiment 115 is the continuously electrically conductive mesh of Embodiment 110, wherein the closed cells have a distribution of perimetral coefficient of variation having a ninetieth percentile in a range of 0.05 to 0.80, the perimetral coefficient of variation being a standard deviation of distances between adjacent vertices in a plurality of vertices of a closed cell divided by a mean of the distances between adjacent vertices.

Embodiment 116 is the continuously electrically conductive mesh of Embodiment 115, wherein the distribution of perimetral coefficient of variation has a tenth percentile in a range of 0.05 to 0.35.

Embodiment 117 is the continuously electrically conductive mesh of Embodiment 110, wherein the closed cells have a distribution of composite coefficient of variation having a ninetieth percentile in a range of 0.1 to 1.05, the composite coefficient of variation being a sum of a radial coefficient of variation and a perimetral coefficient of variation, the radial coefficient of variation being a standard deviation of radial distances to a plurality of vertices of a closed cell from a centroid of the plurality of vertices of the closed cell divided by a mean of the radial distances, the perimetral coefficient of variation being a standard deviation of distances between adjacent vertices in the plurality of vertices of the closed cell divided by a mean of the distances between adjacent vertices.

Embodiment 118 is the continuously electrically conductive tiled electrode of Embodiment 117, wherein the closed cells have a distribution of composite coefficient of variation having a tenth percentile in a range of 0.05 to 0.5.

Embodiment 119 is the continuously electrically conductive mesh of Embodiment 110, wherein the closed cells have a normalized polygonal cell area distribution characterized by a ninetieth percentile less than 1.50.

Embodiment 120 is the continuously electrically conductive mesh of Embodiment 119, wherein the normalized polygonal cell area distribution has a tenth percentile greater than 0.5.

Embodiment 121 is a capacitive touch sensitive apparatus configured to detect a location of an applied touch by detecting a change in a coupling capacitance, comprising:

a touch sensitive viewing area;
a plurality of spaced apart electrically conductive first electrodes disposed in the touch sensitive viewing area and extending along a first direction; and
a plurality of spaced apart electrically conductive second electrodes disposed in the touch sensitive viewing area and extending along a different second direction;
at least one of the first and second electrodes comprising an electrically conductive first mesh repeating across the electrode to form a regular array of the first mesh, the first mesh comprising a plurality of conductive closed cells, each closed cell comprising a plurality of irregularly arranged vertices connecting a plurality of electrically conductive traces.

Embodiment 122 is the capacitive touch sensitive apparatus of Embodiment 121, wherein each of a majority of the electrically conductive traces is curved.

Embodiment 123 is the capacitive touch sensitive apparatus of Embodiment 121, wherein each of the electrically conductive traces is curved.

Embodiment 124 is the capacitive touch sensitive apparatus of Embodiment 121, wherein the first electrodes in the plurality of spaced apart electrically conductive first electrodes are spaced apart along the second direction and the second electrodes in the plurality of spaced apart electrically conductive second electrodes are spaced apart along the first direction.

Embodiment 125 is the capacitive touch sensitive apparatus of Embodiment 121, wherein at least one of the first electrodes comprise the electrically conductive first mesh repeating across the electrode to form the regular array of the first mesh, and at least one of the second electrodes comprises an electrically conductive second mesh repeating across the electrode to form a regular array of the second mesh, the second mesh comprising a plurality of conductive closed cells, each closed cell comprising a plurality of irregularly arranged vertices connecting a plurality of electrically conductive traces.

Embodiment 126 is the capacitive touch sensitive apparatus of Embodiment 121, wherein the at least one of the first and second electrodes further comprises an electrically conductive second mesh different from the first mesh, the second mesh electrically connecting the array of the first mesh.

Embodiment 127 is the capacitive touch sensitive apparatus of Embodiment 121, wherein the array of the first mesh is directly electrically interconnected.

Embodiment 128 is the capacitive touch sensitive apparatus of Embodiment 121, wherein each first mesh in the array of the first mesh shares a common border with an adjacent first mesh in the array of the first mesh such that at least one open cell in the first mesh combines with another open cell in the first mesh along the common border to form a combine closed cell.

Embodiment 129 is the capacitive touch sensitive apparatus of Embodiment 121, wherein the first mesh comprises a plurality of open cells at a perimeter of the first mesh such that for at least one first open cell in the plurality of open cells there is a different second open cell in the plurality of open cells that when translated linearly along at least one direction, combines with the first open cell to form a combined closed cell.

Embodiment 130 is the capacitive touch sensitive apparatus of Embodiment 121, wherein each of a majority of the closed cells of the first mesh has a radial coefficient of variation in a range of 0.02 to 0.3, the radial coefficient of variation being a standard deviation of radial distances to a plurality of vertices of a closed cell from a centroid of the plurality of vertices of the closed cell divided by a mean of the radial distances.

Embodiment 131 is the capacitive touch sensitive apparatus of any one of Embodiments 121 to 130, wherein each of a majority of the closed cells of the first mesh has a perimetral coefficient of variation in a range of 0.02 to 0.6, the perimetral coefficient of variation being a standard deviation of distances between adjacent vertices in a plurality of vertices of a closed cell divided by a mean of the distances.

Embodiment 132 is the capacitive touch sensitive apparatus of any one of Embodiments 121 to 131, wherein each of a majority of the closed cells of the first mesh has a composite coefficient of variation in a range of 0.02 to 0.8, the composite coefficient of variation being a sum of a radial coefficient of variation and a perimetral coefficient of variation, the radial coefficient of variation being a standard deviation of radial distances to the plurality of vertices of the closed cell from a centroid of the plurality of vertices of the closed cell divided by a mean of the radial distances, the perimetral coefficient of variation being a standard deviation of distances between adjacent vertices in the plurality of vertices of the closed cell divided by a mean of the distances between adjacent vertices.

Embodiment 133 is the capacitive touch sensitive apparatus of Embodiment 121, wherein the closed cells of the first mesh have a distribution of radial coefficient of variation having a ninetieth percentile in a range of 0.05 to 0.30, the radial coefficient of variation being a standard deviation of radial distances to a plurality of vertices of a closed cell from a centroid of the plurality of vertices of the closed cell divided by a mean of the radial distances.

Embodiment 134 is the capacitive touch sensitive apparatus of Embodiment 121, wherein the closed cells of the first mesh have a distribution of perimetral coefficient of variation having a ninetieth percentile in a range of 0.05 to 0.80, the perimetral coefficient of variation being a standard deviation of distances between adjacent vertices in a plurality of vertices of a closed cell divided by a mean of the distances between adjacent vertices.

Embodiment 135 is the capacitive touch sensitive apparatus of Embodiment 134, wherein the distribution of perimetral coefficient of variation has a tenth percentile in a range of 0.05 to 0.35.

Embodiment 136 is the capacitive touch sensitive apparatus of Embodiment 121, wherein the closed cells of the first mesh have a distribution of composite coefficient of variation having a ninetieth percentile in a range of 0.1 to 1.05, the composite coefficient of variation being a sum of a radial coefficient of variation and a perimetral coefficient of variation, the radial coefficient of variation being a standard deviation of radial distances to a plurality of vertices of a closed cell from a centroid of the plurality of vertices of the closed cell divided by a mean of the radial distances, the perimetral coefficient of variation being a standard deviation of distances between adjacent vertices in the plurality of vertices of the closed cell divided by a mean of the distances between adjacent vertices.

Embodiment 137 is the capacitive touch sensitive apparatus of Embodiment 121, wherein the closed cells of the first mesh have a distribution of composite coefficient of variation having a tenth percentile in a range of 0.05 to 0.5.

Embodiment 138 is the capacitive touch sensitive apparatus of Embodiment 121, wherein the closed cells of the first mesh have a normalized polygonal cell area distribution characterized by a ninetieth percentile less than 1.50.

Embodiment 139 is the capacitive touch sensitive apparatus of Embodiment 138, wherein the normalized polygonal cell area distribution has a tenth percentile greater than 0.5.

Embodiment 140 is the capacitive touch sensitive apparatus of Embodiment 121, wherein each electrically conductive trace comprises a continuous first derivative along an entire length of the electrically conductive trace.

Embodiment 141 is a method of designing a mesh tile configured to be repeatedly tiled along at least a first direction to form a continuous tiled mesh, the method comprising the steps of:
providing a perimeter of a mesh tile;
forming a plurality of closed cells within and away from the perimeter, each closed cell comprising a plurality of vertices connecting a plurality of traces; and
forming a plurality of open cells along the perimeter, each open cell comprising at least one trace terminating at the perimeter, such that when the mesh tile is repeatedly tiled along at least a first direction to form a tiled mesh along the at least first direction, for each pair of adjacent mesh tiles having portions of the perimeters thereof overlapping each other to form a common border of the adjacent mesh tiles, each of at least a plurality of pairs of corresponding open cells at the common border in the adjacent mesh tiles combine to form a corresponding combined closed cell.

Embodiment 142 is the method of Embodiment 141, wherein the combined closed cell comprises at least one trace extending across the common border at a crossover point and having a continuous first derivative at the crossover point.

Embodiment 143 is the method of Embodiment 141, wherein the combined closed cell comprises at least one vertex on the common border.

Embodiment 144 is the method of Embodiment 141, wherein forming the plurality of closed cells comprises defining a plurality of first seed points within the perimeter and constructing a Voronoi diagram using the first seed points.

Embodiment 145 is the method of Embodiment 144, wherein the Voronoi diagram comprises vertices and straight lines between adjacent vertices, the method further comprising modifying the positions of the vertices of the Voronoi diagram to provide a first modified Voronoi diagram.

Embodiment 146 is the method of Embodiment 145, further comprising replacing the straight lines of the first modified Voronoi diagram with curves to provide a second modified Voronoi diagram.

Embodiment 147 is the method of Embodiment 146, wherein the plurality of vertices and the plurality of traces of the plurality of closed cells are defined by the vertices and curves, respectively, of the second modified Voronoi diagram.

Embodiment 148 is the method of Embodiment 144, further comprising designing a second mesh tile, wherein designing the second mesh tile comprises defining a plurality of second seed points within a perimeter of the second mesh tile and constructing a second Voronoi diagram using the second seed points, wherein no seed point in the plurality of second seed points is coincident with a seed point in the plurality of first seed points when the second mesh tile is overlaid on the first mesh tile in a desired orientation of the first and second mesh tiles.

Embodiment 149 is a method of making an electrode comprising:
designing a mesh tile according to the method of Embodiment 141;
repeating the mesh tile to form the electrode.

Embodiment 150 is the method of Embodiment 141, further comprising forming a plurality of open cells within and away from the perimeter.

Embodiment 151 is a method of making an array of electrodes comprising:
designing a mesh tile according to the method of Embodiment 150;
repeating the mesh tile to form the array of electrodes, wherein regions between adjacent electrodes in the array of electrodes comprise the plurality of open cells within and away from the perimeter of the mesh tile.

Embodiment 152 is a method of making a touch sensor comprising:
making a first array of electrodes according to the method of Embodiment 151, the first array of electrodes comprising electrodes extending in a first direction;
making a second array of electrodes, the second array of electrodes comprising electrodes extending in a second direction different from the first direction,
wherein making the second array of electrodes comprises designing a second mesh tile, wherein designing the second mesh tile comprises defining a plurality of second seed points within a perimeter of the second mesh tile and constructing a second Voronoi diagram using the second seed points, wherein no seed point in the plurality of second seed points is coincident with a seed point in the plurality of first seed points when the second mesh tile is overlaid on the first mesh tile in a desired orientation of the first and second mesh tiles.

Embodiment 153 is the method of Embodiment 141, wherein each of a majority of the closed cells has a radial coefficient of variation in a range of 0.02 to 0.3, the radial coefficient of variation being a standard deviation of radial distances to a plurality of vertices of a closed cell from a centroid of the plurality of vertices of the closed cell divided by a mean of the radial distances.

Embodiment 154 is the method of Embodiment 141, wherein each of a majority of the closed cells has a perimetral coefficient of variation in a range of 0.02 to 0.6, the perimetral coefficient of variation being a standard deviation of distances between adjacent vertices in a plurality of vertices of a closed cell divided by a mean of the distances.

Embodiment 155 is the method of Embodiment 141, wherein each of a majority of the closed cells has a composite coefficient of variation in a range of 0.02 to 0.8, the composite coefficient of variation being a sum of a radial coefficient of variation and a perimetral coefficient of variation, the radial coefficient of variation being a standard deviation of radial distances to the plurality of vertices of the closed cell from a centroid of the plurality of vertices of the closed cell divided by a mean of the radial distances, the perimetral coefficient of variation being a standard deviation of distances between adjacent vertices in the plurality of vertices of the closed cell divided by a mean of the distances between adjacent vertices.

Embodiment 156 is the method of Embodiment 141, wherein the closed cells have a distribution of radial coefficient of variation having a ninetieth percentile in a range of 0.05 to 0.30, the radial coefficient of variation being a standard deviation of radial distances to a plurality of vertices of a closed cell from a centroid of the plurality of vertices of the closed cell divided by a mean of the radial distances.

Embodiment 157 is the method of Embodiment 141, wherein the closed cells have a distribution of perimetral coefficient of variation having a ninetieth percentile in a range of 0.05 to 0.80, the perimetral coefficient of variation being a standard deviation of distances between adjacent vertices in a plurality of vertices of a closed cell divided by a mean of the distances between adjacent vertices.

Embodiment 158 is the method of Embodiment 157, wherein the distribution of perimetral coefficient of variation has a tenth percentile in a range of 0.05 to 0.35.

Embodiment 159 is the method of Embodiment 141, wherein the closed cells have a distribution of composite coefficient of variation having a ninetieth percentile in a range of 0.1 to 1.05, the composite coefficient of variation being a sum of a radial coefficient of variation and a perimetral coefficient of variation, the radial coefficient of variation being a standard deviation of radial distances to a plurality of vertices of a closed cell from a centroid of the plurality of vertices of the closed cell divided by a mean of the radial distances, the perimetral coefficient of variation being a standard deviation of distances between adjacent vertices in the plurality of vertices of the closed cell divided by a mean of the distances between adjacent vertices.

Embodiment 160 is the method of Embodiment 159, wherein the closed cells have a distribution of composite coefficient of variation having a tenth percentile in a range of 0.05 to 0.5.

Embodiment 161 is the method of Embodiment 141, wherein the closed cells have a normalized polygonal cell area distribution characterized by a ninetieth percentile less than 1.50.

Embodiment 162 is the method of Embodiment 161, wherein the normalized polygonal cell area distribution has a tenth percentile greater than 0.5.

Embodiment 163 is a mesh tile configured to be repeatedly tiled along at least a first direction to form a continuous tiled mesh, the mesh tile comprising:
a perimeter;
a plurality of closed cells within and away from the perimeter, each closed cell comprising a plurality of vertices connecting a plurality of traces; and
a plurality of open cells along the perimeter, each open cell comprising at least one trace terminating at the perimeter, such that when the mesh tile is repeatedly tiled along at least a first direction to form a tiled mesh along the at least first direction, for each pair of adjacent mesh tiles having portions of the perimeters thereof overlapping each other to form a common border of the adjacent mesh tiles, each of at least a plurality of pairs of corresponding open cells at the common border in the adjacent mesh tiles combine to form a corresponding combined closed cell, wherein for each of at least a plurality of combined closed cells, the combined closed cell comprises a plurality of irregularly arranged vertices.

Embodiment 164 is the mesh tile of Embodiment 163, wherein the combined closed cell comprises at least one trace extending across the common border at a crossover point and having a continuous first derivative at the crossover point.

Embodiment 165 is the mesh tile of Embodiment 163, wherein the combined closed cell comprises at least one vertex on the common border.

Embodiment 166 is the mesh tile of Embodiment 163, wherein the combined closed cell comprises at least one trace extending across the common border at a crossover point and having a continuous first derivative at the crossover point, and at least one vertex on the common border.

Embodiment 167 is the mesh tile of Embodiment 163 being configured to be repeatedly tiled along a second direction different from the first direction.

Embodiment 168 is the mesh tile of Embodiment 167 being configured to be repeatedly tiled along a third direction different from the first and second directions.

Embodiment 169 is the mesh tile of Embodiment 163, wherein each of a majority of the traces of the closed cells is curved.

Embodiment 170 is the mesh tile of Embodiment 163, wherein each of the traces of the closed cells is curved.

Embodiment 171 is a mesh tile configured to be repeatedly tiled along at least a first direction to form a continuous tiled mesh, the mesh tile comprising:
a perimeter;
a plurality of closed cells within and away from the perimeter, each closed cell comprising a plurality of vertices connecting a plurality of traces; and
a plurality of open cells along the perimeter, each open cell comprising at least one trace terminating at the perimeter, such that for each first open cell in the plurality of open cells along the perimeter, there is a different second open cell in the plurality of open cells along the perimeter that when translated linearly along at least one direction, combines with the first open cell to form a combined closed cell comprising a plurality of irregularly arranged vertices.

Embodiment 172 is the mesh tile of Embodiment 171, wherein the second open cell when translated linearly along the first direction, combines with the first open cell to form the combined closed cell.

Embodiment 173 is the mesh tile of Embodiment 171 being configured to be repeatedly tiled along the first direction and a different second direction to form the continuous tiled mesh.

Embodiment 174 is the mesh tile of Embodiment 173, wherein for a least one third open cell in the plurality of open cells there is a different fourth open cell at the perimeter that when translated linearly along the second direction, combines with the third open cell to form a combined closed cell.

Embodiment 175 is the mesh tile of Embodiment 171, wherein each of a majority of the traces of the closed cells is curved.

Embodiment 176 is the mesh tile of Embodiment 171, wherein each of the traces of the closed cells is curved.

Embodiment 177 is the mesh tile of Embodiment 171, wherein each trace of each closed cell comprises a continuous first derivative along an entire length of the trace.

Embodiment 178 is the mesh tile of Embodiment 171, wherein the combined closed cell comprises at least one trace extending across the common border at a crossover point and having a continuous first derivative at the crossover point.

Embodiment 179 is the mesh tile of Embodiment 171, wherein the combined closed cell comprises at least one vertex on the common border.

Embodiment 180 is the mesh tile of Embodiment 171, wherein the combined closed cell comprises at least one trace extending across the common border at a crossover point and having a continuous first derivative at the crossover point, and at least one vertex on the common border.

Embodiment 181 is the mesh tile of any one of Embodiments 163 to 180, wherein each of a majority of the closed cells has a radial coefficient of variation in a range of 0.02 to 0.3, the radial coefficient of variation being a standard deviation of radial distances to a plurality of vertices of a closed cell from a centroid of the plurality of vertices of the closed cell divided by a mean of the radial distances.

Embodiment 182 is the mesh tile of any one of Embodiments 163 to 180, wherein each of a majority of the closed cells has a perimetral coefficient of variation in a range of 0.02 to 0.6, the perimetral coefficient of variation being a standard deviation of distances between adjacent vertices in a plurality of vertices of a closed cell divided by a mean of the distances.

Embodiment 183 is the mesh tile of any one of Embodiments 163 to 180, wherein each of a majority of the closed cells has a composite coefficient of variation in a range of 0.02 to 0.8, the composite coefficient of variation being a sum of a radial coefficient of variation and a perimetral coefficient of variation, the radial coefficient of variation being a standard deviation of radial distances to the plurality of vertices of the closed cell from a centroid of the plurality of vertices of the closed cell divided by a mean of the radial distances, the perimetral coefficient of variation being a standard deviation of distances between adjacent vertices in the plurality of vertices of the closed cell divided by a mean of the distances between adjacent vertices.

Embodiment 184 is the mesh tile of any one of Embodiments 163 to 180, wherein the closed cells have a distribution of radial coefficient of variation having a ninetieth percentile in a range of 0.05 to 0.30, the radial coefficient of variation being a standard deviation of radial distances to a plurality of vertices of a closed cell from a centroid of the plurality of vertices of the closed cell divided by a mean of the radial distances.

Embodiment 185 is the mesh tile of any one of Embodiments 163 to 180, wherein the closed cells have a distribution of perimetral coefficient of variation having a ninetieth percentile in a range of 0.05 to 0.80, the perimetral coefficient of variation being a standard deviation of distances between adjacent vertices in a plurality of vertices of a closed cell divided by a mean of the distances between adjacent vertices.

Embodiment 186 is the mesh tile of Embodiment 185, wherein the distribution of perimetral coefficient of variation has a tenth percentile in a range of 0.05 to 0.35.

Embodiment 187 is the mesh tile of any one of Embodiments 163 to 180, wherein the closed cells have a distribution of composite coefficient of variation having a ninetieth percentile in a range of 0.1 to 1.05, the composite coefficient of variation being a sum of a radial coefficient of variation and a perimetral coefficient of variation, the radial coefficient of variation being a standard deviation of radial distances to a plurality of vertices of a closed cell from a centroid of the plurality of vertices of the closed cell divided by a mean of the radial distances, the perimetral coefficient of variation being a standard deviation of distances between adjacent vertices in the plurality of vertices of the closed cell divided by a mean of the distances between adjacent vertices.

Embodiment 188 is the mesh tile of Embodiment 187, wherein the closed cells have a distribution of composite coefficient of variation having a tenth percentile in a range of 0.05 to 0.5.

Embodiment 189 is the mesh tile of any one of Embodiments 163 to 180, wherein the closed cells have a normalized polygonal cell area distribution characterized by a ninetieth percentile less than 1.50.

Embodiment 190 is the mesh tile of Embodiment 189, wherein the normalized polygonal cell area distribution has a tenth percentile greater than 0.5.

Embodiment 191 is a continuously electrically conductive tiled electrode comprising a two-dimensional regular array of the mesh tile of any one of Embodiments 163 to 190.

Embodiment 192 is the mesh tile of Embodiment 171 further comprising a second plurality of open cells at corners of the perimeter.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A continuously electrically conductive electrode comprising:
an electrically conductive first mesh repeating across the electrode to form a two-dimensional regular array of the first mesh, the first mesh comprising a plurality of conductive closed cells, each closed cell comprising a plurality of vertices connecting a plurality of electrically conductive traces; and
an electrically conductive second mesh different from the first mesh and comprising a plurality of conductive closed cells, each closed cell comprising a plurality of vertices connecting a plurality of electrically conductive traces, wherein the vertices in the plurality of vertices in each closed cell for at least one of the first and second meshes are irregularly arranged.

2. The continuously electrically conductive electrode of claim 1, wherein the first mesh comprises a plurality of open cells at a perimeter of the first mesh such that for at least one first open cell in the plurality of open cells there is a different second open cell in the plurality of open cells that when translated linearly along at least one direction, combines with the first open cell to form a combined closed cell.

3. The continuously electrically conductive electrode of claim 1, wherein each of a majority of the closed cells of the first mesh has a radial coefficient of variation of at least 0.02, the radial coefficient of variation being a standard deviation of radial distances to the plurality of vertices of a closed cell from a centroid of the plurality of vertices of the closed cell divided by a mean of the radial distances.

4. The continuously electrically conductive electrode of claim 1, wherein each of a majority of the closed cells of the first mesh has a perimetral coefficient of variation of at least 0.02, the perimetral coefficient of variation being a standard deviation of distances between adjacent vertices in a plurality of vertices of a closed cell divided by a mean of the distances.

5. The continuously electrically conductive electrode of claim 1, wherein each of a majority of the closed cells of the first mesh has a composite coefficient of variation of at least 0.02, the composite coefficient of variation being a sum of a radial coefficient of variation and a perimetral coefficient of variation, the radial coefficient of variation being a standard deviation of radial distances to the plurality of vertices of the closed cell from a centroid of the plurality of vertices of the closed cell divided by a mean of the radial distances, the perimetral coefficient of variation being a standard deviation of distances between adjacent vertices in the plurality of vertices of the closed cell divided by a mean of the distances between adjacent vertices.

6. The continuously electrically conductive electrode of claim 1, wherein the closed cells of the first mesh have a distribution of radial coefficient of variation having a ninetieth percentile in a range of 0.05 to 0.30, the radial coefficient of variation being a standard deviation of radial distances to a plurality of vertices of a closed cell from a centroid of the plurality of vertices of the closed cell divided by a mean of the radial distances.

7. The continuously electrically conductive electrode of claim 1, wherein the closed cells of the first mesh have a distribution of perimetral coefficient of variation having a ninetieth percentile in a range of 0.05 to 0.80, the perimetral coefficient of variation being a standard deviation of distances between adjacent vertices in a plurality of vertices of a closed cell divided by a mean of the distances between adjacent vertices.

8. The continuously electrically conductive electrode of claim 1, wherein the closed cells of the first mesh have a distribution of composite coefficient of variation having a ninetieth percentile in a range of 0.1 to 1.05, the composite coefficient of variation being a sum of a radial coefficient of variation and a perimetral coefficient of variation, the radial coefficient of variation being a standard deviation of radial distances to a plurality of vertices of a closed cell from a centroid of the plurality of vertices of the closed cell divided by a mean of the radial distances, the perimetral coefficient of variation being a standard deviation of distances between adjacent vertices in the plurality of vertices of the closed cell divided by a mean of the distances between adjacent vertices.

9. A continuously electrically conductive tiled electrode comprising a first plurality of tiles arranged along a first direction and comprising a first plurality of pairs of adjacent tiles, such that each pair of adjacent tiles in the first plurality of pairs of adjacent tiles comprises a common border and a same plurality of irregularly arranged electrically conductive traces, each conductive trace extending across the common border at a crossover point and having a continuous first derivative at the crossover point.

10. The continuously electrically conductive tiled electrode of claim 9, wherein each tile in the first plurality of tiles comprises a plurality of conductive open cells along the common border with an adjacent tile.

11. The continuously electrically conductive tiled electrode of claim 10, wherein at least one open cell in each tile in the first plurality of tiles combine with an open cell of an adjacent tile at the common border to form a combined closed cell.

12. The continuously electrically conductive tiled electrode of claim 9, wherein each tile in the first plurality of tiles comprises a plurality of open cells along a perimeter of the tile, such that for each first open cell at the perimeter, there is a different second open cell at the perimeter that when translated linearly along the first direction, combines with the first open cell to form a combined closed cell comprising a plurality of irregularly arranged vertices.

13. A continuously electrically conductive electrode comprising an electrically conductive first mesh repeating across the electrode to form a two-dimensional regular array of the first mesh, the first mesh comprising a plurality of conductive closed cells, each of a majority of the closed cells in the plurality of closed cells comprising a plurality of irregularly arranged vertices connecting a plurality of electrically conductive curved traces.

14. The continuously electrically conductive electrode of claim 13, wherein the first mesh comprises a plurality of open cells at a perimeter of the first mesh such that for at least one first open cell in the plurality of open cells there is a different second open cell in the plurality of open cells that when translated linearly along a first direction, combines with the first open cell to form a combined closed cell.

15. A continuously electrically conductive mesh comprising a plurality of vertices connecting a plurality of electrically conductive traces, such that the mesh can be divided into a plurality of same size and shape grid cells forming a continuous two-dimensional grid, wherein a perimeter of each grid cell intersects a plurality of irregularly arranged electrically conductive traces in the plurality of electrically conductive traces without passing through a vertex in the plurality of vertices.

16. The continuously electrically conductive mesh of claim 15, wherein each trace in the plurality of electrically conductive traces has a continuous first derivative along an entire length of the trace.

17-21. (canceled)

22. The continuously electrically conductive mesh of claim 15, wherein each trace in a majority of the electrically conductive traces is curved.

23. The continuously electrically conductive mesh of claim 15, wherein each grid cell comprises a same first mesh.

24. The continuously electrically conductive mesh of claim 15, wherein the first mesh comprises a plurality of open cells at a perimeter of the first mesh such that for at least one first open cell in the plurality of open cells there is a different second open cell in the plurality of open cells that when translated linearly along a first direction, combines with the first open cell to form a combined closed cell.
